(19) United States
(12) Patent Application Publication
(10) Pub. No.: US 2013/0127416 A1
(43) Pub. Date: May 23, 2013

(54) SYSTEM FOR INTERFACING WITH AN ELECTRIC VEHICLE CHARGING STATION AND METHOD OF USING AND PROVIDING THE SAME

(71) Applicant: Eletric Transportation Engineering Corporation d/b/a ECOtality North America, Phoenix, AZ (US)

(72) Inventors: Donald B. Karner, Phoenix, AZ (US); Garrett Beauregard, Phoenix, AZ (US)

(73) Assignee: Eletric Transportation Engineering Corporation d/b/a ECOtality North America, Phoenix, AZ (US)

(21) Appl. No.: 13/713,855

(22) Filed: Dec. 13, 2012

Related U.S. Application Data
(63) Continuation of application No. PCT/US2011/034667, filed on Apr. 29, 2011.
Application No. PCT/US2011/034667 is a continuation of application No. PCT/US2011/037587, filed on May 23, 2011.
Application No. PCT/US2011/037587 is a continuation of application No. PCT/US2011/037588, filed on May 23, 2011.
Application No. PCT/US2011/037588 is a continuation of application No. PCT/US2011/037590, filed on May 23, 2011.
Application No. PCT/US2011/037590 is a continuation of application No. 61/367,316, filed on Jul. 23, 2010.
Application No. PCT/US2011/037590 is a continuation of application No. PCT/US2011/037587, filed on May 23, 2011.
Application No. PCT/US2011/037587 is a continuation of application No. PCT/US2011/037588, filed on May 23, 2011.
Application No. PCT/US2011/037588 is a continuation of application No. PCT/US2011/037590, filed on May 23, 2011.
Application No. PCT/US2011/037587 is a continuation of application No. PCT/US2011/034667, filed on Apr. 29, 2011.
Application No. PCT/US2011/037588 is a continuation of application No. PCT/US2011/034667, filed on Apr. 29, 2011.
Application No. PCT/US2011/037590 is a continuation of application No. PCT/US2011/034667, filed on Apr. 29, 2011.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,337, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,316, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.

(51) Int. Cl. H02J 7/00

(52) U.S. Cl. CPC H02J 7/0042
USPC 320/109

(57) ABSTRACT

Some embodiments include a system for interfacing with an electric vehicle charging station and method of using and providing the same as disclosed herein. Other embodiments of related systems and methods are also disclosed.

### CROSS-REFERENCE TO RELATED APPLICATIONS

This application is a continuation of: (a) International Patent Application Serial No. PCT/US2011/034667, filed Apr. 29, 2011, (b) International Patent Application Serial No. PCT/US2011/037587, filed May 23, 2011, (c) International Patent Application Serial No. PCT/US2011/037588, filed May 23, 2011, and (d) International Patent Application Serial No. PCT/US2011/037590, filed May 23, 2011. International Patent Application Serial No. PCT/US2011/034667, International Patent Application Serial No. PCT/US2011/037587, International Patent Application Serial No. PCT/US2011/037588, and International Patent Application Serial No. PCT/US2011/037590 each claim the benefit of: (1) U.S. Provisional Application Ser. No. 61/367,316, filed Jul. 23, 2010; (2) U.S. Provisional Application Ser. No. 61/367,321, filed Jul. 23, 2010; (3) U.S. Provisional Application Ser. No. 61/367,337, filed Jul. 23, 2010; and (4) U.S. Provisional Application Ser. No. 61/367,317, filed Jul. 23, 2010. Further, International Patent Application Serial No. PCT/US2011/037587, International Patent Application Serial No. PCT/US2011/037588, and International Patent Application Serial No. PCT/US2011/037590 each are a continuation of International Patent Application Serial No. PCT/US2011/034667. The disclosures of U.S. Provisional Application Ser. No. 61/367,316; U.S. Provisional Application Ser. No. 61/367,321; U.S. Provisional Application Ser. No. 61/367,337; U.S. Provisional Application Ser. No. 61/367,317; International Patent Application Serial No. PCT/US2011/034667, International Patent Application Serial No. PCT/US2011/037587, International Patent Application Serial No. PCT/US2011/037588, and International Patent Application Serial No. PCT/US2011/037590 are incorporated herein by reference in their entirety.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to systems for charging electric vehicles, and relates more particularly to such systems operating as dynamic constituents of a network of electric vehicle charging stations and methods of using and manufacturing the same.

### DESCRIPTION OF THE BACKGROUND

Electric vehicle charging stations are becoming more common in light of the increasing use of energy conscious methods of transportation; however, charging an electric vehicle can be time consuming and can require more complicated procedures than are required when merely filling up a vehicle with a petroleum-based fuel. Accordingly, a need or potential for benefit exists for a system that can provide users of electric vehicle charging stations with a dynamic consumer interface while using the station.

### BRIEF DESCRIPTION OF THE DRAWINGS

To facilitate further description of the embodiments, the following drawings are provided in which:

FIG. 1 illustrates a representative block diagram for a system, according to one embodiment;

FIG. 2 illustrates a computer system that is suitable for implementing an embodiment of the system of FIG. 1;

FIG. 3 illustrates a representative block diagram of an example of the elements included in the circuit boards inside chassis of the computer system of FIG. 2;

FIG. 4 illustrates a representative block diagram for a system, according to another embodiment;

FIG. 5 illustrates an exemplary embodiment of a method;

FIG. 6 illustrates a procedure of facilitating communication between at least one user and at least one electric vehicle charging station, according to the embodiment of FIG. 5;

FIG. 7 illustrates a procedure of transferring electricity between the at least one electric vehicle charging station and the rechargeable energy storage system of the electric vehicle(s), according to the embodiment of FIG. 5;

FIG. 8 illustrates an exemplary embodiment of a method of providing an electric vehicle charging station for charging a rechargeable energy storage system of an electric vehicle;

FIG. 9 illustrates a block diagram of an exemplary system for charging a rechargeable energy storage system of an electric vehicle of a user, according to one embodiment;

FIG. 10 illustrates a flow chart for an exemplary embodiment of a method of operating an electric vehicle charging station to charge a rechargeable energy storage system of an electric vehicle of a user; and

FIG. 11 illustrates a procedure of administrating payment by the user, according to the embodiment of FIG. 10.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc., in question is or is not removable.

The term “real time” is defined with respect to operations carried out as soon as practically possible upon the occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

As used herein, the term “electric grid” follows the conventionally understood definition of the term (e.g., any electrical network configured to deliver electricity from one or more suppliers (e.g., utility companies, etc.) to consumers). Accordingly, the term “electric grid” should be broadly understood to include one or more electrical networks of varying scale. For example, “electric grid” can include an electrical network defined by a geographical area (e.g., one or more continents, countries, states, municipalities, ZIP codes, regions, etc.) and/or defined by some other context (e.g., the electrical network of a local utility company, etc.).

### DETAILED DESCRIPTION OF EXAMPLES OF EMBODIMENTS

Some embodiments include a system for charging a rechargeable energy storage system of an electric vehicle. The system comprises an administrative module, an electricity transmission module, a measurement module, a timing module, and a communication module. Further, the system comprises an electric vehicle charging station comprising the administrative module, the electricity transmission module, the measurement module, the timing module, and the communication module. The administrative module can be configured to authenticate a user via radio frequency identification and to administrate payment by the user for using the system to charge the rechargeable energy storage system. Further, the electricity transmission module can be configured to make electricity available to charge the rechargeable energy storage system. Likewise, the measurement module can be configured to measure a first measurement of the electricity used to charge the rechargeable energy storage system, and the timing module can be configured to measure at least one of (a) a second measurement of a first quantity of time during which the electricity is used to charge the rechargeable energy storage system or (b) a third measurement of a second quantity of time during which the electric vehicle occupies a space located adjacent to the electricity transmission module. Meanwhile, the communication module can be configured to intermediate communication between an operations module, the administrative module, the electricity transmission module, the measurement module, and the timing module. The operations module can be located remotely from the electric vehicle charging station.

Further embodiments include a method of providing a system for charging a rechargeable energy storage system of an electric vehicle. The method can comprise providing an electric vehicle charging station. Providing the electric vehicle charging station can comprise: providing an administrative module configured to authenticate a user via radio frequency identification and to administrate payment by the user for using the system to charge the rechargeable energy storage system; providing an electricity transmission module configured to make electricity available to charge the rechargeable energy storage system; providing a measurement module configured to measure a first measurement of the electricity used to charge the rechargeable energy storage system; and providing a timing module configured to measure at least one of (a) a second measurement of a first quantity of time during which the electricity is used to charge the rechargeable energy storage system or (b) a third measurement of a second quantity of time during which the electric vehicle occupies a space located adjacent to the electricity transmission module. Further, the method can comprise configuring an operations module, the administrative module, the electricity transmission module, the measurement module, and the timing module to communicate with each other. The operations module can be located remotely from the electric vehicle charging station.

Various embodiments include a method of operating an electric vehicle charging station to charge a rechargeable energy storage system of an electric vehicle. The method can be implemented via execution of computer instructions configured to run at one or more computer processing modules and configured to be stored in one or more non-transitory computer memory storage modules. The method can comprise: receiving radio frequency identification data from a user of the electric vehicle charging station; providing the radio frequency identification data to an operations module to authenticate an identity of the user, the operations module being located remotely from the electric vehicle charging station and comprising a computer database; receiving a request from the user to charge the rechargeable energy storage system of the electric vehicle; making electricity available from the electric vehicle charging station to the rechargeable energy storage system of the electric vehicle after receiving the request; providing at least one of (a) a first measurement of a quantity of electricity used to charge the rechargeable energy storage system of the electric vehicle, (b) a second measurement of a first quantity of time during which the rechargeable energy storage system is being charged, or (c) a third measurement of a second quantity of time during which the electric vehicle occupies a space located adjacent to the electric vehicle charging station, to the operations module; providing information received from the user to the operations module; and administrating payment by the user based on the at least one of: (a) the first measurement, (b) the second measurement, (c) the third measurement, (d) permitting the user to charge the rechargeable energy storage system, (e) permitting the electric vehicle to occupy the space located adjacent to the electric vehicle charging station, or (f) a fractional quantity of the rechargeable energy storage system charged.

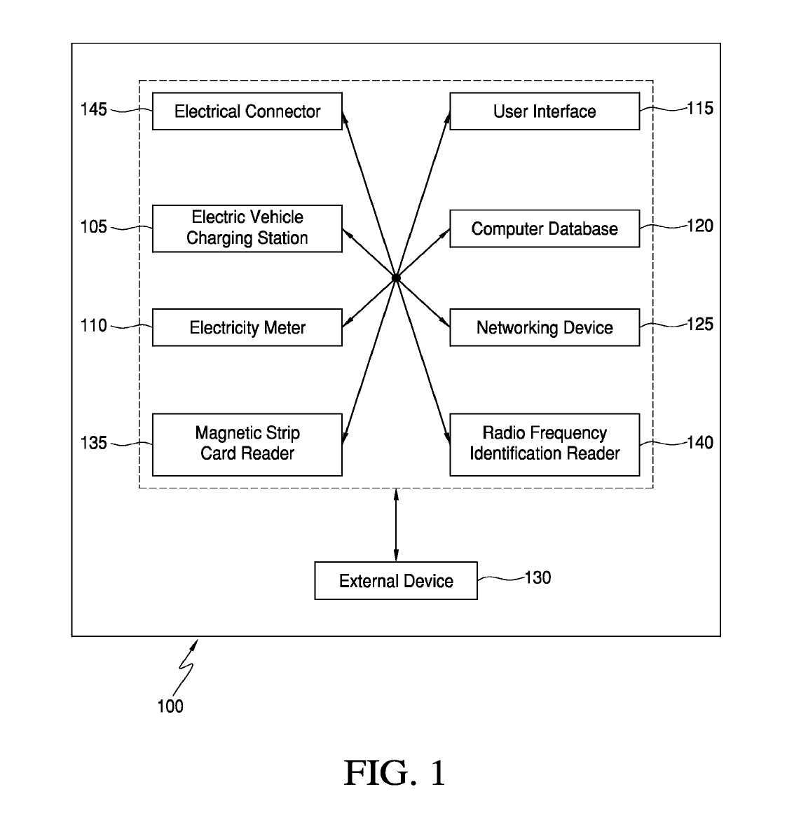

Turning to the figures, FIG. 1 illustrates a block diagram of a system 100. System 100 is merely exemplary and is not limited to the embodiments presented herein. System 100 can be employed in many different embodiments or examples not specifically depicted or described herein. In some embodiments, system 100 and/or at least one component of system 100 can be configured to operate with or in conjunction with at least one computer system, as described below.

In some embodiments, system 100 can comprise a public system. Where system 100 comprises a public system, system 100 can comprise at least one of a government public system or a commercial public system (including a non-profit public system). Where system 100 comprises a public system, system 100 can be operated for free or for a fee. In other embodiments, system 100 can comprise a private system. Where system 100 comprises a private system, system 100 can comprise at least one of a domestic private system or a commercial private system (including a non-profit private system). Where system 100 comprises at least one of a domestic private system or a commercial private system, system 100 can be privately leased or owned.

In many embodiments, any single component/sub-component or combination of components/sub-components of system 100 can be configured to communicate with any other single component/sub-component or combination of components/sub-components of system 100. Where any single component/sub-component or combination of components/sub-components of system 100 is configured to communicate with any other single component/sub-component or combination of components/sub-components of system 100, communication can comprise passing information between the any single component/sub-component or combination of components/sub-components of system 100 and the any other single component/sub-component or combination of components/sub-components of system 100.

In many embodiments, system 100 can be configured to operate as part of a charging network. The charging network can comprise multiple ones of system 100. In some embodiments, each system 100 of the multiple ones of system 100 can be configured to communicate with at least one other system 100 of the charging network; while in other embodiments, the multiple ones of system 100 are not configured to communicate with each other. In many embodiments, a third party can obtain a membership to the charging network to permit the third party to use the charging network as a member of the charging network. The third party can refer to a person that is not yet a member of the charging network. The third party and/or the member can comprise a user of system 100 and/or user interface 115, as described below. The third party can join the charging network by providing various information about herself (i.e., creating a user profile). The information can be similar to the user inputs, as described below. Creating the user profile can streamline the interaction of a member with system 100 and/or the charging network. In the same or different embodiments, the member can receive preference over a non-member (e.g., the third party) for use of system 100 and/or the charging network and/or for electricity use during high demand periods. In the same or different embodiments, the third party can join the network by providing a one-time and/or a recurring fee or, in some examples, at no cost.

System 100 can be configured to comply with the International Organization for Standardization (ISO) standards for safety (e.g., ISO 6469). System 100 can comprise an automatic shutoff feature for emergencies. Likewise, system 100 can incorporate insulating materials to prevent contact with electrically conductive components of system 100. System 100 can also comprise a charge circuit interrupting device (CCID) and/or a ground monitoring circuit.

Referring to FIG. 1, system 100 comprises electric vehicle charging station 105. Electric vehicle charging station 105 can be configured to make electricity available to charge a rechargeable energy storage system of an electric vehicle and/or rechargeable energy storage systems of multiple electric vehicles. In a different embodiment, electric vehicle charging station 105 can be configured to make electricity available from one or more rechargeable energy storage systems of one or more electric vehicles to an electric grid operated by a power company. Any of the multiple electric vehicles can be similar or identical to the electric vehicle, as described below. In the same or different embodiments, electric vehicle charging station 105 can be configured to make electricity available to charge a rechargeable energy storage system of an electric device other than the electric vehicle.

In many embodiments, electric vehicle charging station 105 can be configured to receive electricity from one or more electric grids. Electric vehicle charging station 105 can be configured to receive the electricity from the electric grid(s) via (e.g., by electrically coupling with) a National Electrical Manufacturers Association (NEMA) 6-50R electrical receptacle receiving electricity from the electric grid(s).

In some embodiments, when electric vehicle charging station 105 makes make electricity available to charge a rechargeable energy storage system, the rechargeable energy storage system(s) and/or the electric vehicle(s), as described below, can be configured to control a flow rate or electric power level of the electricity being used to charge the rechargeable energy storage system(s) (e.g., where electric vehicle charging station 105 comprises a level 2 electric vehicle supply equipment, as described below). In other embodiments, when electric vehicle charging station 105 makes make electricity available to charge a rechargeable energy storage system, electric vehicle charging station 105 can be configured to control the flow rate or electric power level of the electricity being used to charge the rechargeable energy storage system(s) (e.g., where electric vehicle charging station 105 comprises a level 3 electric vehicle supply equipment, as described below).

Electric vehicle charging station 105 can be implemented, at least in part, using one or more electrical networks comprising one or more circuit boards (e.g., an electric vehicle supply equipment board) and/or various other related electrical circuitry and/or components configured to operate electric vehicle charging station 105 and/or to make the electricity available to charge the rechargeable energy storage system. User interface 115 can be configured to communicate with and/or control these one or more electrical networks in order to control electric vehicle charging station 105, as described below.

In many embodiments, electric vehicle charging station 105 can comprise an electric vehicle supply equipment (e.g., a device for making electricity available to charge a rechargeable energy storage system of an electric vehicle). In other embodiments, electric vehicle charging station 105 can comprise an industrial electric charger (e.g., an on-board AC electric charger, a off-board DC electric charger). In still other embodiments, electric vehicle charging station 105 can be configured to charge a rechargeable energy storage system of the electric vehicle via electrical induction. Electric vehicle charging station 105 can comprise either of a stand-alone unit or a wall-mounted unit.

In various embodiments, the electric vehicle supply equipment can comprise a level 1 electric vehicle supply equipment, a level 2 electric vehicle supply equipment, and/or a level 3 electric vehicle supply equipment. The level 1 electric vehicle supply equipment can comprise either of a level 1 alternating current (AC) electric vehicle supply equipment or a level 1 direct current (DC) electric vehicle supply equipment. Meanwhile, the level 2 electric vehicle supply equipment can comprise either of a level 2 AC electric vehicle supply equipment or a level 2 DC electric vehicle supply equipment. Furthermore, the level 3 electric vehicle supply equipment can comprise either of a level 3 AC electric vehicle supply equipment or a level 3 DC electric vehicle supply equipment. In some embodiments, the level 2 electric vehicle supply equipment and/or the level 3 electric vehicle supply equipment can also be referred to as a fast charger. In many embodiments, the electric vehicle supply equipment can make available electricity comprising a maximum electric current of 30 amperes (A) or 48 A. When the maximum electric current of the electric vehicle supply equipment comprises 30 A, the electric vehicle supply equipment can be configured to make available electricity comprising an electric current of one or more of 12 A, 16 A, or 24 A. When the maximum electric current of the electric vehicle supply equipment comprises 48 A, the electric vehicle supply equipment can be configured to make available electricity comprising an electric current of one or more of 12 A, 16 A, 24 A, or 30 A.

For example, the level 1 AC electric vehicle supply equipment can make available electricity comprising an electric voltage of approximately 120 volts (V) and an electric current: greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, the level 1 electric vehicle supply equipment can comprise a standard grounded domestic electrical outlet. Meanwhile, the level 2 AC electric vehicle supply equipment can make available electricity comprising an electric voltage greater than or equal to approximately 208 V and less than or equal to approximately 240 V and an electric current greater than or equal to approximately 0 A and less than or equal to approximately 80 A AC. Furthermore, a level 3 electric vehicle supply equipment can make available electricity comprising an electric voltage greater than or equal to approximately 208 V and an electric current greater than or equal to approximately 80 A AC (e.g., 240 V AC (single phase), 208 V AC (triple phase), 480 V AC (triple phase). In some embodiments, the electric voltages for the level 1 electric vehicle supply equipment, the level 2 electric vehicle supply equipment, and/or the level 3 electric vehicle supply equipment can be within plus or minus (±) ten percent (%) tolerances of the electric voltages provided above.

In other examples, the level 1 DC electric vehicle supply equipment can make available electricity comprising electric power greater than or equal to approximately 0 kiloWatts (kW) and less than or equal to approximately 19 kW. Meanwhile, the level 2 DC electric vehicle supply equipment can make available electricity comprising electric power greater than or equal to approximately 19 kW and less than or equal to approximately 90 kW. Furthermore, level 3 electric vehicle supply equipment can make available electricity comprising electric power greater than or equal to approximately 90 kW. In some embodiments, the term fast charger can refer to an electric vehicle supply equipment making available electricity comprising an electric voltage between approximately 300 V-500 V and an electric current between approximately 100 A-400 A DC.

The industrial electric charger (e.g., the on-board AC electric charger, the off-board DC electric charger) can make available electricity comprising electric power greater than or equal to approximately 3 kW and less than or equal to approximately 33 kW. The off-board DC electric charger can make available electricity comprising an electric voltage greater than or equal to approximately 18 V DC and less than or equal to approximately 120 V DC.

In some embodiments, electric vehicle charging station 105 can also comprise a compressed gas charging station or can otherwise be implemented as the compressed gas charging station, instead. In further embodiments, electric vehicle charging station 105 can comprise a rechargeable energy storage system exchange station. In various embodiments, electric vehicle charging station 105 can comprise a gaseous or liquid fuel dispensing system. In other embodiments, electric vehicle charging station 105 can be configured for wireless energy transfer (e.g., charging). Wireless energy transfer can comprise inductive, microwave, or other non-conductive forms of energy transfer.

In some embodiments, electric vehicle charging station 105 can be coupled to an electrical grid and can be configured to receive electricity from a remote location (e.g., from utility-owned electric stations). In other embodiments, electric vehicle charging station 105 can comprise at least one generator configured to generate electricity at and/or near electric vehicle charging station 105 using solar energy generation, wind energy generation (e.g., turbines), tidal energy generation, hydroelectric energy generation, and/or another suitable source of renewable energy.

In many embodiments, the electric vehicle can comprise a full electric vehicle and/or any other grid-connected vehicle. In the same or different embodiments, the one or more vehicle(s) can comprise a car, a truck, motorcycle, a bicycle, a scooter, a boat, a train, an aircraft, an airport ground support equipment, and/or a material handling equipment (e.g., a fork-lift), etc.

In many embodiments, the rechargeable energy storage system can comprise a device configured to store electricity for the vehicle or for the other electric device. The rechargeable energy storage system can comprise (a) one or more batteries and/or one or more fuel cells, (b) one or more capacitive energy storage systems (e.g., super capacitors such as electric double-layer capacitors), and/or (c) one or more inertial (e.g., flywheel) energy storage systems. In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery such as a gel battery and/or an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) and/or a lithium (e.g., lithium-ion (Li-ion)) battery. In some embodiments, where the rechargeable energy storage system comprises more than one battery, the batteries can all comprise the same type of battery. In other embodiments, where the rechargeable energy storage system comprises more than one battery, the batteries can comprise at least two types of batteries. In many embodiments, the at least one fuel cell can comprise at least one hydrogen fuel cell.

Referring to FIG. 1, system 100 comprises electricity meter 110. In the same or different embodiments, electricity meter 110 can be configured to measure the amount of electricity transferred: (a) from electric vehicle charging station 105 to the rechargeable energy storage system (e.g., of the electric vehicle); or (b) from the rechargeable energy storage system. In the same or different embodiments, electricity meter 110 can be a part of and/or configured to communicate with electric vehicle charging station 105. In other embodiments, electricity meter 110 can be separate from electric vehicle charging station 105 and/or configured to communicate with electric vehicle charging station 105. In the same or different embodiments, electricity meter 110 can comprise a certified energy and demand meter. With respect to electricity meter 110, the term “certified energy and demand meter” can refer to an energy and demand meter that is suitable for use by, and meeting all requirements of, electric utility companies for measuring and billing electricity. In the same or different embodiments, electricity meter 110 can be configured to perform revenue grade electricity metering. In the same or different embodiments, electricity meter 110 can comprise an electronic electricity meter. In other embodiments, electricity meter 110 can comprise an electromechanical electricity meter. In many embodiments, electricity meter 110 can comprise a smart electricity meter. In various embodiments, electricity meter 110 can comprise a self-contained electricity meter. Electricity meter 110 can be electrically coupled to electric vehicle charging station 105.

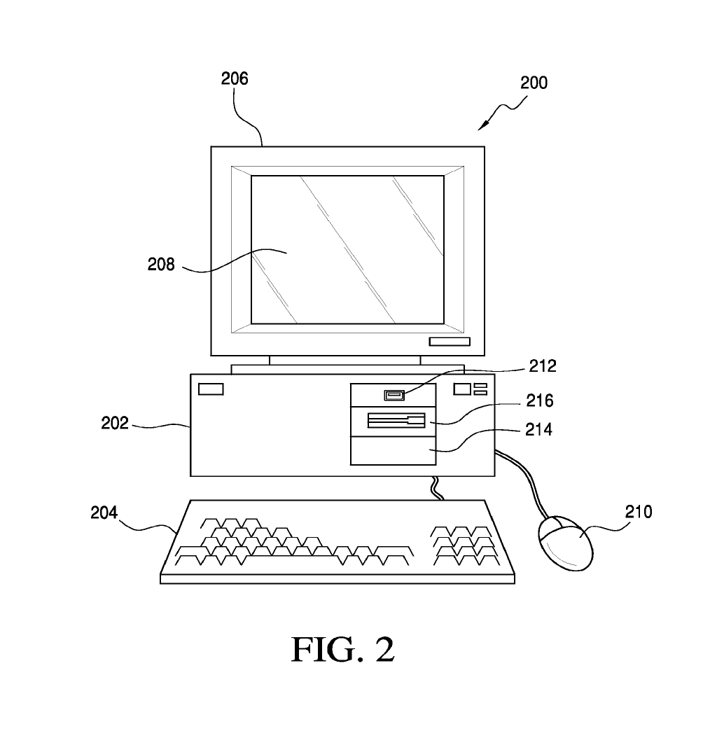

Referring to FIG. 1, system 100 comprises user interface 115. In the same or different embodiments, user interface 115 can be configured to operate electric vehicle charging station 105 and/or to communicate with a user and/or multiple users, as described below. User interface 115 can comprise a computer system similar or identical to computer system 200 (FIG. 2), as described below, configured to facilitate operating electric vehicle charging station 105 and/or communicating with the user(s).

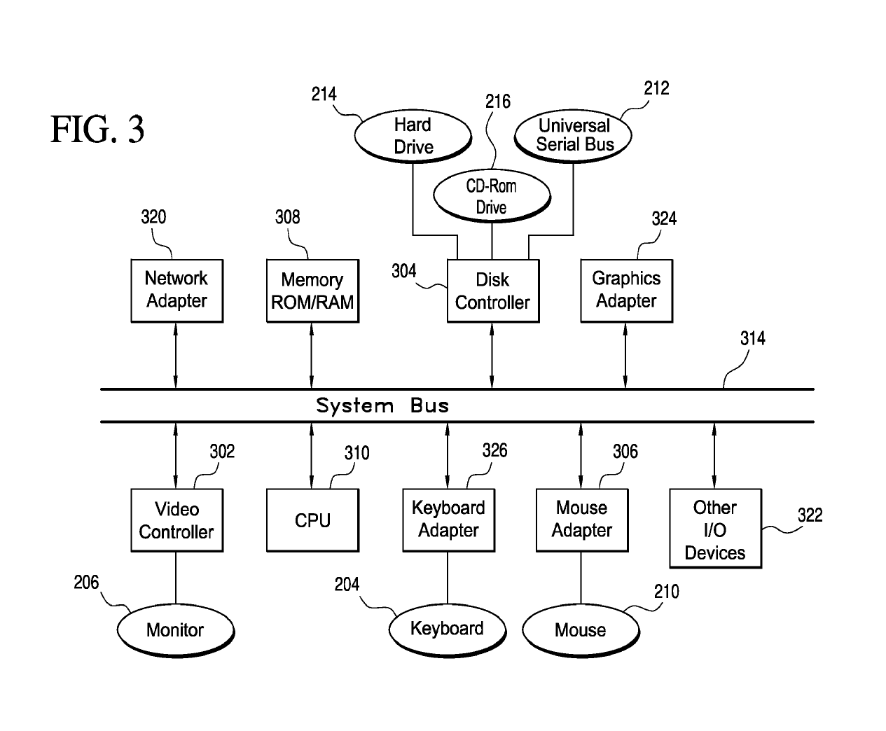

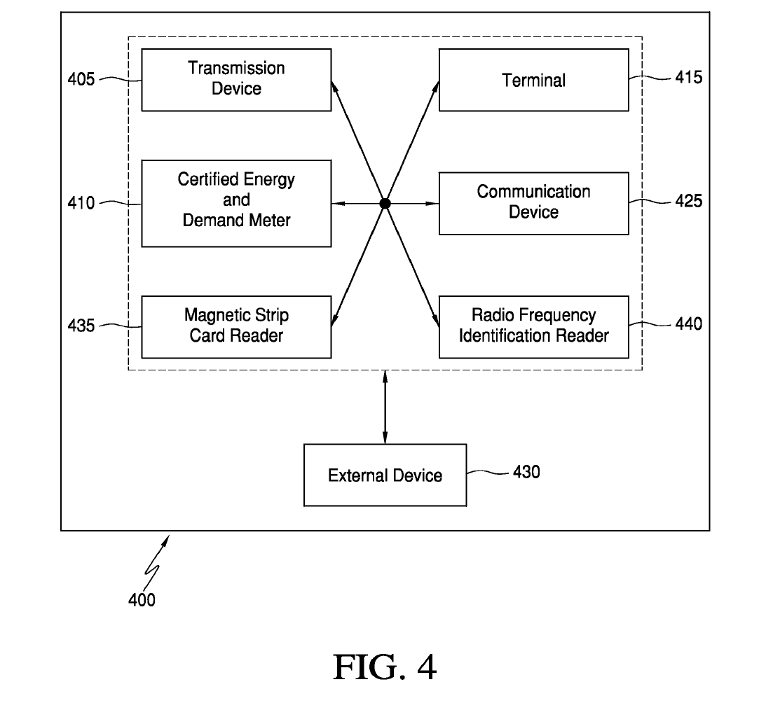

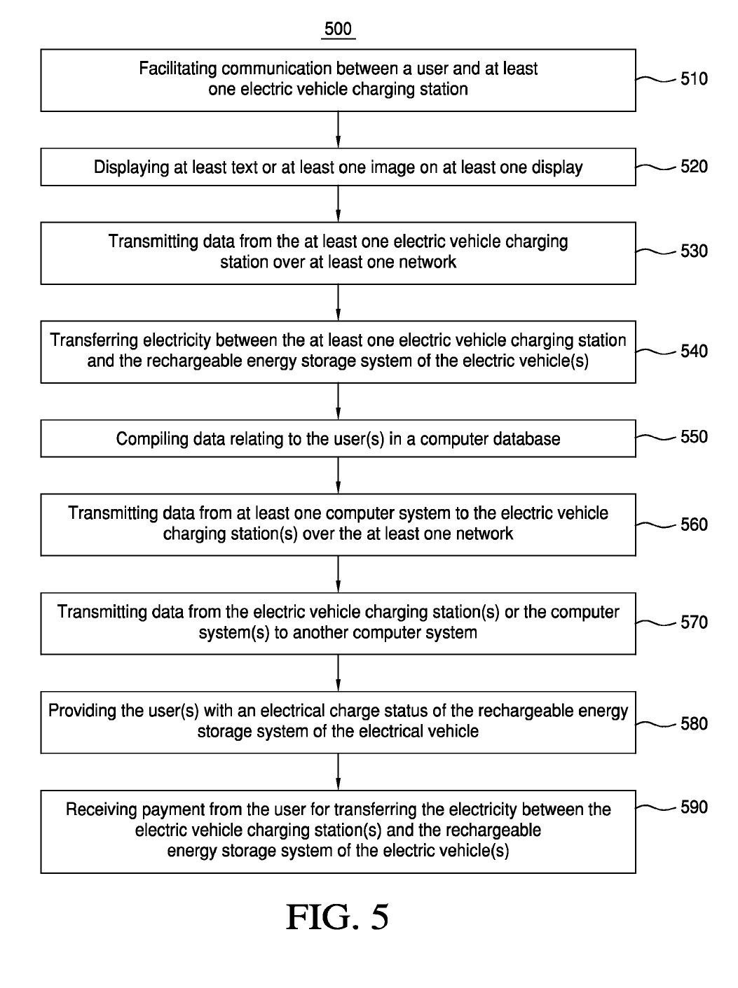

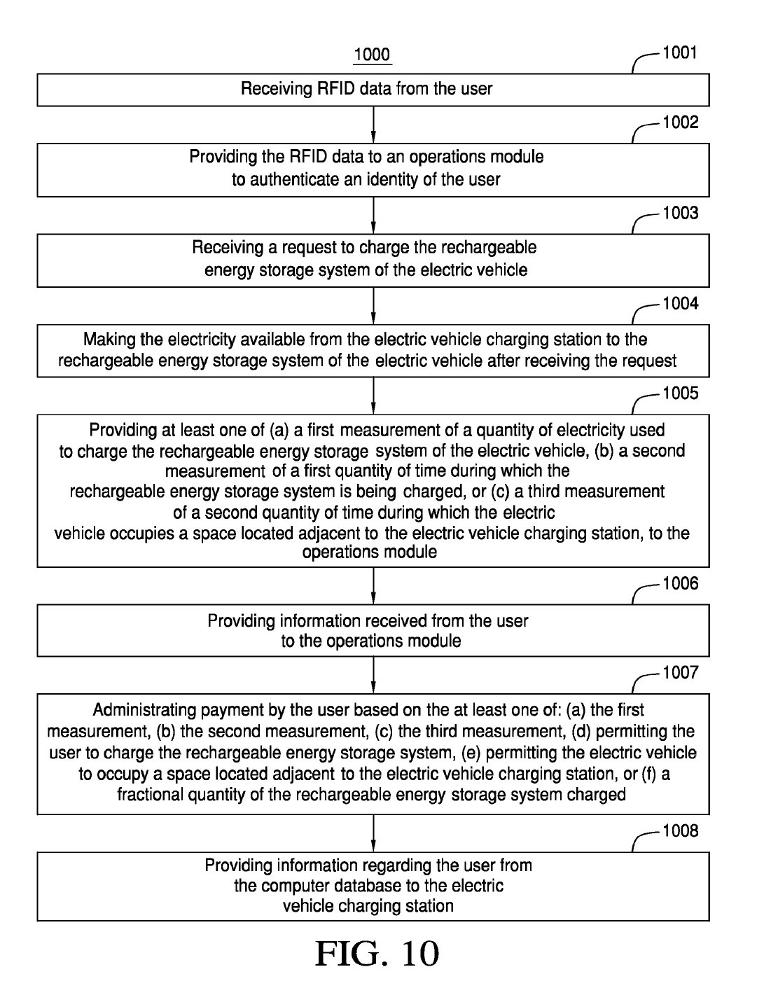

Skipping ahead now in the drawings, FIG. 2 illustrates an exemplary embodiment of computer system 200 that can be suitable for implementing an embodiment of the computer system of user interface 115 (FIG. 1), of external device 130 (FIG. 1), a computer system comprising computer database 120 (FIG. 1), and/or operations module 950 (FIG. 9), and/or at least part of system 100 (FIG. 1), system 400 (FIG. 4), system 900 (FIG. 9), method 500 (FIG. 5), and/or method 1000 (FIG. 10). Computer system 200 includes chassis 202 containing one or more circuit boards (not shown), Universal Serial Bus (USB) 212, Compact Disc Read-Only Memory (CD-ROM) and/or Digital Video Disc (DVD) drive 216, and hard drive 214. A representative block diagram of the elements included on the circuit boards inside chassis 202 is shown in FIG. 3. Central processing unit (CPU) 310 in FIG. 3 is coupled to system bus 314 in FIG. 3. In various embodiments, the architecture of CPU 310 can be compliant with any of a variety of commercially distributed architecture families.

System bus 314 also is coupled to memory 308, where memory 308 includes both read only memory (ROM) and random access memory (RAM). Non-volatile portions of memory 308 or the ROM can be encoded with a boot code sequence suitable for restoring computer system 200 (FIG. 2) to a functional state after a system reset. In addition, memory 308 can include microcode such as a Basic Input-Output System (BIOS). In some examples, the one or more storage modules of the various embodiments disclosed herein can include memory 308, USB 212 (FIGS. 2-3), hard drive 214 (FIGS. 2-3), and/or CD-ROM or DVD drive 216 (FIGS. 2-3). In the same or different examples, the one or more storage modules of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 3, various I/O devices such as disk controller 304, graphics adapter 324, video controller 302, keyboard adapter 326, mouse adapter 306, network adapter 320, and other I/O devices 322 can be coupled to system bus 314. Keyboard adapter 326 and mouse adapter 306 are coupled to keyboard 204 (FIGS. 2-3) and mouse 210 (FIGS. 2-3), respectively, of computer system 200 (FIG. 2). While graphics adapter 324 and video controller 302 are indicated as distinct units in FIG. 3, video controller 302 can be integrated into graphics adapter 324, or vice versa in other embodiments. Video controller 302 is suitable for refreshing monitor 206 (FIGS. 2-3) to display images on a screen 208 (FIG. 2) of computer system 200 (FIG. 2). Disk controller 304 can control hard drive 214 (FIGS. 2-3), USB 212 (FIGS. 2-3), and CD-ROM drive 216 (FIGS. 2-3). In other embodiments, distinct units can be used to control each of these devices separately.

In some embodiments, network adapter 320 can be part of a WNIC (wireless network interface controller) card (not shown) plugged or coupled to an expansion port (not shown) in computer system 200. In other embodiments, the WNIC card can be a wireless network card built into computer system 200. A wireless network adapter can be built into computer system 200 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 320 can be a wired network adapter. In some embodiments, networking device 125 can comprise network adapter 320.

Although many other components of computer system 200 (FIG. 2) are not shown, such components and their interconnection are well known to those of ordinary skill in the art. Accordingly, further details concerning the construction and composition of computer system 200 and the circuit boards inside chassis 202 (FIG. 2) are not discussed herein.

When computer system 200 in FIG. 2 is running, program instructions stored on a USB equipped electronic device connected to USB 212, on a CD-ROM or DVD in CD-ROM and/or DVD drive 216, on hard drive 214, or in memory 308 (FIG. 3) are executed by CPU 310 (FIG. 3). A portion of the program instructions, stored on these devices, can be suitable for carrying out at least part of methods 500 and/or 1000 (FIGS. 5 & 10) and one or more functions of system 100 (FIG. 1), system 400 (FIG. 4), and/or system 900 (FIG. 9).

Although computer system 200 is illustrated as a desktop computer in FIG. 2, there can be examples where computer system 200 may take a different form factor (e.g., a laptop, a mobile device such as a smart phone, a computer system of user interface 115 when electric vehicle charging station 105 comprises user interface 115, etc.) while still having functional elements similar to those described for computer system 200. In some embodiments, computer system 200 may comprise a single computer (e.g., the desktop computer, the laptop computer, the mobile device, and/or computer system of user interface 115 when electric vehicle charging station 105 comprises user interface 115), a single server, or a cluster or collection of computers or servers, or a cloud of computers or servers (e.g., the computer system comprising computer database 120).

In some examples, a single server can include modules to perform various methods, procedures, processes, and activities. In other examples, a first server can include a first portion of these modules. One or more second servers can include a second, possibly overlapping, portion of these modules. In these examples, the computer system can comprise the combination of the first server and the one or more second servers.

Returning now to FIG. 1, user interface 115 can comprise one or more displays. User interface 115 can communicate with the user with the one or more displays. The one or more displays can comprise one or more electronic displays. In the same or different embodiments, at least one of the one or more displays can comprise a black and white display and/or a color display. In the same or different embodiments, at least one of the one or more displays can comprise one or more touch screen display. In some embodiments, the one or more displays can comprise a first display and a second display. In the same or different embodiments, the first display can be oriented any one of above, below, left, or right of the second display. In the same or different embodiments, the first display can be any of larger or smaller than or equal to the second display in size. In many embodiments, a first display of the one or more displays can have a diagonal measurement of greater than or equal to approximately 15 centimeters (5.9 inches) and less than or equal to approximately 44 centimeters (17.4 inches). For example, the first display can have a diagonal measurement of approximately 17 centimeters (6.7 inches). In the same or different embodiments, a second display of the one or more displays can have a diagonal measurement of greater than or equal to approximately 91 centimeters (36 inches) and less than or equal to approximately 117 centimeters (46 inches). For example, the second display can have a diagonal measurement of approximately 107 centimeters (42 inches). In the same or different embodiments, user interface 115 can comprise one or more additional displays than the first display and the second display. In the same or different embodiments, user interface 115 can comprise one or more speakers. User interface 115 can be part of and/or located at electric vehicle charging station 105. In other embodiments, user interface 115 can be separate from and/or located apart from electric vehicle charging station 105. In the same or different embodiments, user interface 115 can be electrically coupled and/or configured to communicate with electric vehicle charging station 105. In one example, part of user interface 115 that provides information to the user can be part of and/or at electric vehicle charging station 105, and part of user interface 115 that performs calculations, etc., can be located remotely from electric vehicle charging station 105. In a different example, a first part of user interface 115 that provides information to the user can be located at electric vehicle charging station 105, and a second part of user interface 115 that provides information can be located remotely from electric vehicle charging station 105. In many embodiments, where user interface 115 comprises the first display and the second display, the first display can be configured to instruct at least one user, as described below, to reference the second display, and/or vice versa.

In many embodiments, at least one of the one or more displays can comprise a monochrome cathode ray tube display, a color cathode ray tube display, a direct-view bistable storage tube display, a split-flap display, a flip-disc display, a monochrome plasma display, a light-emitting diode display, an eggcrate display, a vacuum fluorescent display, a twisted nematic field effect liquid crystal display, a pin screen display, a thin film transistor liquid crystal display, a full-color plasma display, an organic light-emitting diode display, an electronic paper display, or an electroluminescent display. The one or more displays can be similar and/or different types of displays.

In many embodiments, user interface 115 can comprise a touch screen display, a keyboard, a keypad, a voice recognition device, a magnetic strip card reading device, a barcode reading device, an optical recognition device, a wireless networking device (e.g., a radio frequency communication device, a microwave communication device, and/or an infrared communication device), and/or a wired networking device. The keyboard and/or keypad can be implemented as hardware and/or as a virtual touch screen keyboard and/or keypad displayed on one of more of the display(s) (e.g., the first display). The radio frequency communication device can comprise a radio frequency identification (RFID) scanner and/or transmitter. In many embodiments, at least one of the magnetic strip card reading device or the radio frequency identification scanner and/or transmitter can be part of system 100, but may not be part of user interface 115, as described below. In the same or different embodiments, where the at least one of the magnetic strip card reading device and/or the radio frequency identification scanner and/or transmitter are part of system 100 but are not part of user interface 115, the magnetic strip card reading device and/or the radio frequency identification scanner and/or transmitter can be configured to communicate with user interface 115. The at least one of the magnetic strip card reading device and/or the radio frequency identification scanner and/or transmitter can be similar to magnetic strip card reader 135 and/or radio frequency identification reader 140, respectively, as described below.

Electric vehicle charging station 105 and/or user interface 115 can comprise at least one data cable electrically coupled to electric vehicle charging station 105 and/or user interface 115 for communication with the electric vehicle(s). The at least one data cable can be integrated with one or more electrical cable(s), each coupling one electrical connector 145 to electric vehicle charging station 105, as described below. In other embodiments, the at least one data cable can be separate from the one or more electrical cable(s). In some embodiments, electric vehicle charging station 105 and/or user interface 115 can be configured to communicate with the electric vehicle(s) using the one or more electric cable(s) via a power line communication protocol. In these embodiments, electric vehicle charging station 105 and/or user interface 115 transmit electrical information over at least one electrical line that electric vehicle charging station 105 uses to transmit electricity to the rechargeable energy storage system of the vehicle(s).

User interface 115 can comprise at least one printing device (e.g., to provide printed information to the user(s)). Likewise, user interface 115 can comprise at least one device for accepting and/or distributing currency (e.g., to conduct monetary transactions with the user(s)).

User interface 115 can be configured to communicate with the user(s) and/or the electric vehicle(s). User interface 115 can be configured to receive at least one user and/or database input. User interface 115 can operate electric vehicle charging station 105 based on the user input(s) and/or the vehicle input(s). User interface 115 can be configured to receive the user input(s) from the user(s). In many embodiments, user interface 115 can be configured to receive the user input(s) from at least one of the one or more displays, the keyboard, the keypad, the voice recognition device, the magnetic strip card reading device, the barcode reading device, the wireless networking device, and/or the wired networking device. The user(s) can comprise a driver, a passenger, and/or an owner of the electric vehicle(s).

In some embodiments, through communication with user interface 115, the user(s) can become a member of the charging network comprising electric vehicle charging station 105, as described in greater detail above. User interface 115 can comprise a browsing interface (e.g., a menu) configured (a) to facilitate entry of the user input(s), the database input(s), and/or the vehicle input(s) and/or (b) to allow interactive navigation of the outputs, which are described below. The outputs can be organized and classified for the ease of navigation by the user(s). The browsing interface can be configured to be personal to each of the members and/or such that members can customize the browsing interface in a manner specific to the member(s). The browsing interface can permit access for the one or more user(s) to their user profiles. The browsing interface can permit “drag and drop” navigation. The browsing interface can comprise one or more gauges showing one or more gauge readings. In some embodiments, the gauge reading(s) can comprise (i) at least one of the outputs, (ii) an electricity quantity and/or cost savings to user(s) for a charge, and/or (iii) a reduction in carbon dioxide output (a) by modifying a charge request and/or (b) in comparison with providing equivalent energy to a vehicle configured to operate using internal combustion. In various embodiments, new gauges can be developed for and/or added to the browsing interface based on feedback from the user(s). The members can protect their personal browsing interface via member unique user names and/or passwords, an RFID tag, or any other electronic security system. Information communicated between the user(s) and user interface 115 and/or computer database 120, which is described below, can be encrypted for additional protection. The one or more user(s) can be required to answer challenge questions to access their personal browsing interface and/or user profiles as well as to obtain their user names and/or passwords in the event that the user(s) forget(s).

User interface 115 can be configured to receive at least one vehicle input. User interface 115 can be configured to receive the vehicle input(s) from the vehicle(s).

User interface 115 can be configured to provide/receive the user input(s) and/or the vehicle input(s) to/from a computer database configured to receive, aggregate, compile, store, and/or provide information regarding the user(s) and/or the vehicle(s). The database can comprise and/or can be similar to computer database 120, as described below. Where the user input(s) and/or the vehicle input(s) comprise multiple user inputs and/or vehicle inputs, user interface 115 can be configured to receive some of the user inputs and/or vehicle inputs from the user(s) and/or the vehicle(s) and some of the inputs from the computer database after the user logs in or otherwise authenticates himself/herself at system 100 and/or user interface 115.

The user input(s), the vehicle input(s) and/or the database input(s) can comprise a desired level of charge (e.g., a percentage charge—a full charge, a half charge, or otherwise) of the rechargeable energy storage system of the electric vehicle. In the same or different embodiments, the vehicle input(s) can comprise an existing level of charge of the rechargeable energy storage system.

The user input(s) and/or database input(s) can comprise at least one of a make, model, and/or manufacturing year of the electric vehicle(s), a type of rechargeable energy storage system of the electric vehicle(s), a history of use of the rechargeable energy storage system, a type, size, and/or other detail(s) of the battery or batteries of the rechargeable energy storage system and/or electric vehicle(s), at least one preference of the user(s), at least one response of the user(s), at least one user inquiry of the user(s), an amount of time the user(s) are willing to wait to receive a desired level of charge for the rechargeable energy storage system, a time and/or day at which the user(s) require the electric vehicle(s) for use, at least one duration of time over which to charge the rechargeable energy storage system, a maximum price per unit of energy that the user(s) are willing to pay for the charge, a maximum price that the one or more user(s) are willing to pay for charging the rechargeable energy storage system of the electric vehicle(s) to a desired level of charge, at least one electrical characteristic of the charge for the rechargeable energy storage system (e.g., amperage, voltage, and/or wattage, etc.), a distance and/or route the user(s) desire to travel, an electricity meter read date, an internal combustion engine comparison miles (kilometers) per gallon (liter) for the electric vehicle(s), a reservation for at least one interval of time during which to use electric vehicle charging station 105, a reservation for at least one interval of time during which to use an alternative electric vehicle charging station, an odometer reading for the vehicle(s), a request that electric vehicle charging station 105 make available electricity from an alternative energy source (e.g., wind, nuclear, hydroelectric, tidal, and/or solar energy, etc.), or feedback from the user(s) on using electric vehicle charging station 105. Meanwhile, the user input(s) and/or database input(s) can further comprise at least one interest of the user(s), at least one interest of a passenger of the vehicle(s), a telephone number of the user(s), and/or an email address of the user(s). Also, the user input(s) and/or database input(s) can further comprise a request to book a temporary property, such as a motel or hotel room. Furthermore, the user input(s) can comprise at least one coupon for electric vehicle charging station 105, another electric vehicle charging station, and/or some unrelated product and/or service. Likewise, the user and/or at least one database input can further comprise one or more of a request to provide a fastest charge, a request to provide a cheapest charge, a request to provide an environmentally cleanest charge, a request to charge the rechargeable energy storage system only within a range of utility energy cost rates, a request to charge the rechargeable energy storage system outside of certain energy demand periods, a request to give preference to one or more loads (e.g., appliances) drawing electricity from a same electrical system (e.g., a home and/or a commercial electrical system) as electric vehicle charging station 105, and/or a request not to make available electricity to the rechargeable energy storage system when one or more loads (e.g., a washing machine, a dryer, an oven, an air conditioner, etc.) are drawing electricity from the same electrical system from which electric vehicle charging station 105 draws electricity.

The vehicle input(s) and/or database input(s) can comprise at least one of a make, model, and/or manufacturing year of the one or more vehicle(s), a type of rechargeable energy storage system of the electric vehicle(s), a history of use of the rechargeable energy storage system, a type, size, and/or other detail(s) of the battery or batteries of the electric vehicle(s), an odometer reading for the electric vehicle(s), or a total capacity of charge for the rechargeable energy storage system. In some embodiments, other user input(s) and/or database input(s) described earlier could also be vehicle inputs.

System 100 and/or user interface 115 can be configured to provide outputs to the user(s) via the one or more displays. In some embodiments, the outputs can comprise at least portions of first data and/or second data, as described below. In many embodiments, the outputs can further comprise instructions for operating electric vehicle charging station 105. In the same or different embodiments, the instructions can be stored in one or more memory units of at least one computer system (e.g., the computer system of user interface 115) operating as part of system 100 and/or as part of at least one component of system 100, as described above.

In many embodiments, outputs can further comprise one or more of at least one option to charge the rechargeable energy storage system of the electric vehicle(s) to a predetermined or otherwise specified level of charge, an electric power level of a current charge, at least one predicted cost of providing a requested charge, at least one predicted cost of providing a full charge, at least one actual cost of providing a requested charge, at least one actual cost of providing a full charge, at least one suggested alternative amount of charge, at least one predicted amount of time to provide a requested charge, at least one predicted amount of time to provide a full charge, at least one actual amount of time to provide a requested charge, at least one actual amount of time to provide a full charge, at least one suggested time to begin a charge, at least one suggested time to complete a charge, at least one interval of time during which to reserve electric vehicle charging station 105 (where the electric vehicle charging station can be along a route intended to be driven by the user(s) of the electric vehicle(s)), at least one interval of time during which to reserve a electric vehicle charging station other than electric vehicle charging station 105, at least one option to switch reservation times with at least one other user and a potential savings in cost by so doing, at least one option to buy a reserved time from at least one other user, at least one option to sell electricity to electric vehicle charging station 105, system 100 and/or a utility company, at least one value of a payment to the one or more user(s) for selling the electricity to electric vehicle charging station 105, system 100, and/or the utility company, at least one option to use alternative energy for the charge, information on the current status of the charge of the rechargeable energy storage system of the electric vehicle, information about a charging network comprising electric vehicle charging station 105 and/or system 100 and at least one other electric vehicle charging station and/or system similar to electric vehicle charging station 105 and/or system 100, or information on becoming a member of the charging network. Meanwhile, outputs can further comprise at least one location of one or more alternative electric vehicle charging stations where the user(s) can charge the electric vehicle(s) (e.g., locations of other electric vehicle charging stations in the charging network) and/or a status of the one or more alternative electric vehicle charging stations, where the location(s) can be provided by at least distance, zip code, geographic location, area code, a geographical route of travel, a geographical destination, or cost of electricity at the location(s). In the same or different embodiments, the location(s) can be provided at least in a list or on a map. Outputs can further comprise a notification that the charge has been completed and/or a notification that the charge has been prematurely ended.

For locations where laws and/or regulations restrict or forbid commercial advertising in conjunction with certain related applications (e.g., refueling a vehicle, etc.), the outputs can be limited to outputs that do not constitute commercial advertisements. The outputs can comprise one or more visual (e.g., text, images) and/or audible outputs (e.g., sound bytes and/or music). In some examples, the one or more visual outputs and the one or more audible outputs can be complimentary/unrelated and/or provided simultaneously/separately. In many embodiments, where the one or more displays comprise the first display and the second display, the first display can be configured to provide at least a first portion of the visual outputs. In the same or different embodiments, the second display can be configured to provide at least a second portion of the visual outputs.

In the same or different embodiments, user interface 115 can be configured to provide at least a portion of the outputs to a computer system (e.g., any computer system apart from the electric charging station including, for example, a mobile device such as a smart mobile telephone and/or a personal computer such as a laptop or desktop computer) of the user(s) via networking device 125, as described below. In the same or different embodiments, user interface 115 can be configured to provide at least a portion of the outputs to the computer system via at least one telephone call, a short message service, and/or an electronic mail message. For example, user interface 115 can send at least one telephone call, short message service (e.g, a text message), and/or electronic mail message to the computer system indicating that the charge is completed, that the charger was disconnected prior to completing the charge, and/or that the charge was terminated prior to completing the charge.

User interface 115 can be interactive and continue to provide additional outputs on at least one of the one or more displays based on receiving at least one subsequent user input and/or vehicle input.

User interface 115 can be configured to permit the user(s) to use the internet via at least one of the one or more displays. User interface 115 can be configured to connect to and communicate over the internet using at least one networking device 125, as described below.

User interface 115 can be configured to iteratively calculate an approximate quantity of time remaining to provide the desired level of charge from the existing level of charge. For example, user interface 115 can be configured to continuously recalculate the amount of time required to provide a charge to the rechargeable energy storage system of the vehicle(s) over the course of charging the rechargeable energy storage system.

User interface 115 and/or system 100 can be configured to monitor and regulate electric vehicle charging station 105 to permit the one or more users to optimize and/or customize the charge for the rechargeable energy storage system. For example, the cost to arrange charging times around peak load hours can be a factor for minimizing cost to the user. Peak times can vary and can be sensitive to variation as the cost of electricity rises. Accordingly, knowledge of the time of the day alone can be insufficient for a user to optimize his or her charging schedule. In the same or different embodiments, user interface 115 can be configured to calculate various other charge information to optimize and/or customize the charge for the one or more user(s) based on the user input(s), the database input(s), and/or the vehicle input(s) while factoring energy and demand data for one or more electric grids configured to provide the electricity to electric vehicle charging station 105, alternative energy resource data for alternative energy sources configured to provide electricity to electric vehicle charging station 105, availability of electric vehicle charging station 105 and/or other electric vehicle charging stations of the charging network, supplementary load data, and/or vehicle range history data. In some embodiments, user interface 115 and/or system 100 can operate electric vehicle charging station 105 using an energy arbitrage scheme to buy and sell electricity during the course of a charge as part of the optimization (e.g., for a minimum overall cost) for the charge.

Energy and demand data can comprise past/present/future electric utility costs/values for two or more periods (e.g., four periods) (time and/or cost), sequences instructions for charges from utilities, and/or past/present/future demand on the electric grid(s) providing electricity to electric vehicle charging station 105, and the like. Alternative energy resource data can be similar to energy and demand data as applied to alternative energy-based resources (e.g., solar, wind, thermal, nuclear, tidal, etc.). In the same or different embodiments, the availability of electric vehicle charging station 105 and/or other electric vehicle charging stations of the charging network can comprise times and dates when electric vehicle charging station 105 and/or the other electric vehicle charging station of the charging network are available for use by the user(s) (i.e., times and dates when electric vehicle charging station 105 is not already reserved for use by another user). In the same or different embodiments, supplementary load data can comprise data referring to local loads (e.g., appliances, etc.) on a local electric system (e.g., a home and/or commercial electrical system) to which electric vehicle charging station 105 is coupled. In the same or different embodiments, vehicle range history data can comprise historical data on one or more distances the one or more vehicle(s) have traveled given one or more levels of charge.

In the same or different embodiments, user interface 115 can be configured to iteratively calculate and reconcile both the amount of time required to provide a charge to the rechargeable energy storage system of the one or more vehicle(s) over the course of charging the rechargeable energy storage system and the cost to the user(s) to provide the desired charge.

For example, in some embodiments, user interface 115 can be configured to determine whether there is sufficient electricity available to perform a desired charge, whether there is electricity available for a cost at which the one or more user(s) are willing to pay, what the total amount of charge time will occur when charging only for certain prices for electricity, whether the user(s) could pay less for the total charge if electric vehicle charging station 105 charges the electric vehicle(s) only at certain times and/or for certain electrical loads and/or electricity costs, etc.

In various examples, user interface 115 can be configured to calculate the estimated cost of a charge using an integrative technique to predict the cost of a requested charge by determining the time necessary to charge the rechargeable energy storage system of each of the electric vehicle(s) and finding the product of the calculated time and the predicted cost of electricity at various intervals during that time. Meanwhile, user interface 115 can be configured to calculate suggestions for optimal times to begin and complete charging the rechargeable energy storage system of the electric vehicle(s) by referencing the availability of the one or more user(s) against the availability of electric vehicle charging station 105 and against the cost of electricity during those various times. In the same or different examples, user interface 115 can be configured to calculate suggestions on various intervals over which to start and stop charging the rechargeable energy storage system to better factor different times of availability and costs of electricity into the optimization scheme.

In many embodiments, user interface 115 can be configured to operate in real time. In the same or different embodiments, at least one module and/or sub-module in user interface 115 can be configured to perform an operation upon the occurrence of another operation by at least one of or a combination of the other modules of user interface 115 and/or the other components of system 100. In the same or different embodiments, at least one module and/or sub-module in user interface 115 can be configured to perform an operation upon the occurrence of another operation by a combination of the other modules of user interface 115 and/or the other components of system 100 when the other modules of user interface 115 and/or the other components of system 100 operate in a specified sequence. In still other embodiments, at least one module and/or sub-module in user interface 115 can be configured to operate upon the passage of a certain interval of time.

Referring to FIG. 1, in many embodiments, system 100 can comprise at least one computer database 120. For example, the at least one computer database 120 can be implemented as one or more of an XML (Extensible Markup Language) database, MySQL, or an Oracle® database. In the same or different embodiments, computer database 120 can be configured to store user data of the user(s) (e.g., the user profile(s), as described above) and/or first data and/or second data, as described below. Computer database 120 can be in electrical communication with user interface 115. In some embodiments, computer database 120 can be located at and/or part of user interface 115. In other embodiments, computer database 120 can be located apart and/or separate from user interface 115. In the same or different embodiments, computer database 120 can be stored in one or more memory units of at least one computer system operating as part of system 100 and/or user interface 115 and/or at least one component of system 100 and/or user interface 115, as described above. In these embodiments, the at least one computer system can be similar to computer system 200 (FIG. 2), as described above. In the same or different embodiments, where external device 130, as described below, comprises a computer server, computer database 120 can be stored in one or more memory units of external device 130. In some embodiments, computer database 120 can comprise a public database. In the same or different embodiments, computer database 120 can comprise a private database.

User data can comprise user profile data. User profile data can comprise the user input(s) and/or the vehicle input(s). Where the user profile data comprises the user input(s) and/or the vehicle input(s), the user profile data can comprise at least one preference and/or interest of the user(s). Computer database 120 can be configured to receive, aggregate, compile, store, and/or provide the user input(s) and/or the vehicle input(s) as user profile data. Where computer database 120 is configured to collect and store the user input(s) and/or vehicle input(s) as user profile data, computer database 120 can automatically provide the user input(s) and/or the vehicle input(s) to user interface 115 as the database input(s).

Meanwhile, the user profile data can further comprise user transactional data. User transactional data can comprise a record of one or more transactions of the user(s) for the charging network. Also, user profile data can further comprise user reservation data. User reservation data can comprise a record of one or more reservations of the user(s) for the charging network.

In many embodiments, user interface 115 can be configured to provide a reservation system for the charging network. In many embodiments, the reservation system can comprise a system by which the one or more user(s) can reserve at least one date and time to use at least one electric vehicle charging station of the charging network. In various embodiments, where the at least one electric vehicle charging station comprises more than one electric vehicle charging station and the at least one date and time comprises more than one date and time, the one or more user(s) can reserve at least a first date and time at a first electric vehicle charging station and at least a second date and time at the electric vehicle charging station other than the first electric vehicle charging station. In many embodiments, where the charging network comprises multiple electric vehicle charging stations, the multiple electric vehicle charging stations can all be located in a single general location (e.g., a vehicle service station). In other embodiments, where the charging network comprises multiple electric vehicle charging stations, the multiple electric vehicle charging stations can be located across a region. In the same or different embodiments, the region can be a municipality, a county, a state, a country, or all of the world.

Referring to FIG. 1, system 100 comprises at least one networking device 125 to communicate with at least one external device 130 apart from the electric vehicle charging station. In some embodiments, at least one networking device 125 can be part of and/or located at user interface 115 and/or electric vehicle charging station 105. In the same or different embodiments, at least one networking device 125 can comprise one or more wired and/or a wireless networking devices. The at least one networking device 125 can be electrically coupled to user interface 115 and/or electric vehicle charging station 105. In some embodiments, the at least one networking device 125 can be part of and/or located at user interface 115 and/or electric vehicle charging station 105.

In the same or different embodiments, system 100 and/or user interface 115 can comprise at least one antenna. In the same or different embodiments, the wireless networking device can be configured to communicate with external device 130 via the antenna(s). The wireless networking device can comprise at least one photodiode receiver configured to convert infrared radiation to an electric current. The wireless networking device can be configured to communicate with external device 130 via the at least one photodiode receiver configured to convert infrared radiation to an electric signal. The wireless networking device can be configured to operate and communicate over terrestrial communications and/or space-based communications.

The wired networking device can be configured to electrically communicate with external device 130 over a computer network. In the same or different embodiments, the computer network can comprise at least one of a worldwide network, a local area network, a wide area network, a metropolitan area network, a home area network, or a personal area network. In many embodiments, the local are network can comprise an Ethernet local area network connection.

Likewise, the wireless networking device can be configured to electrically communicate with external device 130 over the computer network. In these embodiments, the home area network can comprise a ZigBee® network connection, and/or the personal area network can comprise a Bluetooth™ network connection. Meanwhile, the wireless networking device can be configured to communicate with external device 130 via a wireless Wi-Fi 802.11(a), (b), (g), or (n) network connection.

In various embodiments, the at least one wireless networking device can comprise at least one device configured to communicate via a cellular telephone network. For example, the at least one device configured to operate over a cellular telephone network can be configured to communicate via a cellular telephone network connection protocol comprising at least one of a code division multiple access (CDMA) (e.g., IS-95) network, a global system for mobile communications (GSM) network, a time division multiple access (TDMA) network, and/or an orthogonal frequency-division multiplexing (OFDM) network, and the like. In some embodiments, the CDMA and/or GSM networks can be configured to operate in 2G, 3G, and/or 4G (e.g., implementing multiple OFDM networks operating with multi-carrier code division multiple access (MC-CDMA) and multiple-input and multiple-output (MIMO) configurations) modalities, and the like.

In other embodiments, the at least one wireless networking device can comprise at least one radio frequency identification reader. The at least one radio frequency identification reader can be and/or can be similar to radio frequency identification reader 140, as described below.

External device 130 can comprise a computer system. The computer system can be similar or identical to computer system 200 (FIG. 2), as described above. The computer system can comprise a mobile device such as a smart phone, a personal computer, and/or a computer server. External device 130 can also comprise a computer system being part of and/or located at the electric vehicle(s). Likewise, external device 130 can be another electric vehicle charging station than electric vehicle charging station 105. In some embodiments, the user(s) can provide payments for using electric vehicle charging station 105 and/or other electric vehicle charging stations of the charging network via the computer system.

For example, when external device 130 comprises a mobile device (e.g., a smart phone), external device 130 can be configured to operate a mobile device software application and to communicate with electric vehicle charging station 105, user interface 115 and/or another external device 130 (e.g., a computer system comprising computer database 120 and/or facilitating a charging network comprising one or more electric vehicle charging stations comprising electric vehicle charging station 105) with the mobile device software application via networking device 125. The mobile device software application can be configured to operate with one or more mobile devices and/or mobile device operating systems. The mobile device software applications can be available (e.g., via computer download) for both member users and non-member users, as described above. With the mobile device software application, the user(s) can receive information about any of the electric vehicle charging stations of the charging network (e.g., availability) and charging status updates and notifications (e.g., start and duration of charging, charging completion, electrical fault, premature disconnection, etc.), as described herein. In some embodiments, the information can be received via e-mail and/or short messaging service (e.g., text message), as described herein, as opposed to through the mobile device software application directly. Through the mobile device software application and/or the user's profile, the user can determine how he or she prefers to receive the information.

The mobile device software application can be configured to provide the user's current location automatically, using a wireless network connection and/or global positioning system of the mobile device, or manually, where the user manually provides a location (e.g., zip code, city, address, etc.), to user interface 115 and/or the other external device 130. Upon receiving the current location, user interface 115 and/or the other external device 130 can provide the mobile device software application and/or the mobile device with data from which to generate a map of nearby electric vehicle charging stations (e.g., of the charging network), as well as driving directions to any of the electric vehicle charging stations. By tapping on an icon on the map representing one of the electric vehicle charging station, the user can view the availability (e.g., available, in use, and/or unavailable) and charging status of that electric vehicle charging station as well as additional details (e.g., the type of charging available (e.g., level 2 and/or level 3 charging), pricing, and information (e.g., local businesses, etc.) about the site of the electric vehicle charging station). Users of the mobile device software application can also define a default location, specify preferred units of measurement (e.g., Metric, Standard), and manage their accounts for the charging network using the mobile device software application.

Where external device 130 comprises a computer server, user interface 115 can be configured to receive first data and/or second data, as described below, via networking device 125. Likewise, user interface 115 can be configured to receive both of the first data and the second data from external device 130.

In the same or different embodiments, the first data can comprise charger information that is: (a) stored in one or more memory modules of a computer system comprising computer database 120 (e.g., external device 130); (b) stored in the one or more memory units of another computer system of system 100 (e.g., a computer system of user interface 115); and/or (c) calculated and/or received (e.g., from a computer system that is not part of system 100) by system 100. Charger information can comprise at least one of: dates and times during which electric vehicle charging station 105 and/or another electric vehicle charging station of the charging network is available, dates and times during which electric vehicle charging station 105 and/or another electric vehicle charging station of the charging network is reserved, locations of electric vehicle charging stations other than electric vehicle charging station 105, a present cost of electricity, past costs of electricity for at least one past time and date, predictions of future costs of electricity for at least one future time and date, a current load on an electric grid to which the electric vehicle charging station is coupled, past loads on the electric grid for the at least one past time and date, predictions of future loads on the electric grid for the at least one future time and date, or an amount of available electricity from the electric grid. Charger information can further comprise locations where the user(s) can charge his or her electric vehicle, where the locations can be provided by at least distance, zip code, geographic location, area code, a geographical route of travel, a geographical destination, or cost of electricity at the locations. In the same or different embodiments, the locations can be provided at least in a list or on a map.

In the same or different embodiments, the second data can comprise multiple marketing messages that are: (a) stored in one or more memory modules of a computer system comprising computer database 120 (e.g., external device 130); (b) stored in the one or more memory units of another computer system of system 100 (e.g., a computer system of user interface 115); and/or (c) calculated and/or received (e.g., from a computer system that is not part of system 100) by system 100. In the same or different embodiments, multiple marketing messages can comprise two or more of one or more advertisements, one or more food menus, one or more movie times, one or more sporting event times, and/or one or more coupons. For example, the advertisement can comprise an advertisement for a business located close to electric vehicle charging station 105. The food menu can comprise a food menu for a restaurant located close to electric vehicle charging station 105. The movie time can comprise at least one movie time for a movie at a movie theater located close to electric vehicle charging station 105. The sporting event time can comprise at least one sporting event time for a sporting event at a sporting event venue located close to electric vehicle charging station 105. The coupon can comprise at least one coupon for a product of a business (e.g., a grocery store) located close to electric vehicle charging station 105. Being located close to electric vehicle charging station 105 can refer to a distance that is easy, comfortable, and/or manageable to walk by an average person. For example, a distance located close to electric vehicle charging station 105 can comprise a distance that is less than approximately one, two, five, or ten miles (less than approximately 1.6, 3.2, 8.0, or 16.0 kilometers) from electric vehicle charging station 105.

In other embodiments, the advertisement can comprise an advertisement for a business that is not located close to electric vehicle charging station 105. The food menu can comprise a food menu for a restaurant that is not located close to electric vehicle charging station 105. The movie time can comprise at least one movie time for a movie at a movie theater that is not located close to electric vehicle charging station 105. The sporting event time can comprise at least one sporting event time for a sporting event at a sporting event venue that is not located close to electric vehicle charging station 105. The coupon can comprise at least one coupon for a product of a business (e.g., a grocery store) that is not located close to electric vehicle charging station 105. Not being located close to electric vehicle charging station 105 can refer to a distance that is not easy, comfortable, and/or manageable to walk by an average person. For example, the distance can comprise a distance that is more than approximately one, two, five or ten miles (more than approximately 1.6, 3.2, 8.0, or 16.0 kilometers) from electric vehicle charging station 105.

Meanwhile, the second data can also comprise a governmental message, a news message, a political message, and/or a public service announcement. The public service announcement can comprise an amber alert, weather information, weather warnings, road conditions, security warnings, and/or traffic conditions.

Referring back to FIG. 1, system 100 can comprise magnetic strip card reader 135. Magnetic strip card reader 135 can be configured to operate with and/or can comprise the at least one device for accepting/distributing currency, as described above with respect to user interface 115. In other embodiments, system 100 can comprise radio frequency identification reader 140, as illustrated in FIG. 1. Radio frequency identification reader 140 can comprise an interrogator device configured to read radio frequency identification data. For example, radio frequency identification reader 140 can be implemented to read a radio frequency identification tag provided by the at least one user and/or the at least one vehicle. When the user(s) are members of the charging network, as described above, the members can purchase or otherwise receive one or more smart cards to communicate with system 100, user interface 115, and/or electric vehicle charging station 105 via radio frequency identification reader 140. Meanwhile, radio frequency identification reader 140 can also be implemented for contactless card reading (e.g., reading contactless credit cards, etc.). Members can authenticate their identity using the smart cards. In still further embodiments, system 100 can comprise a parking meter, a light pole, and/or a public telephone.

Referring once again to FIG. 1, system 100 can comprise one or more electrical connector(s) 145 coupled to electric vehicle charging station 105 via an electric cable. Each of the one or more electrical connector(s) 145 can be coupled to the electric vehicle charging station via its own respective electric cable. Electrical connector 145 can comprise a J1772 standard electrical connector. In other embodiments, electrical connector 145 can comprise an IEC 62196 electrical connector. In various embodiments, electrical connector 145 can comprise a JARI Level 3 DC electrical connector. In many embodiments, the electric cable can comprise a length of approximately 10, 12, 14, 16, 18, or 20 feet (3.1, 3.7, 4.3, 4.9, 5.5, or 6.1 meters). Where electric vehicle charging station 105 has more than one electrical connector 145, electric vehicle charging station 105 can provide and/or receive electricity to and/or from multiple vehicles simultaneously and/or a second vehicle via a second electrical connector 145 while a first vehicle is coupled to a first electrical connector 145 but is not currently receiving electricity therefrom.

In some embodiments, electric vehicle charging station 105 can be configured to terminate charging the rechargeable energy storage system in the event that electrical connector 145 and/or the electric cable to which it is coupled, experience a level of strain exceeding a particular threshold. Accordingly, system 100 and/or electric vehicle charging station 105 can comprise sensors configured to sense strain in electrical connector 145 and/or the electric cable to determine if the level of strain exceeds the particular threshold. System 100 can also be configured to communicate with the vehicle(s) in the event that the user(s) attempt to drive away without disconnecting electrical connector 145 from the rechargeable energy storage device.

System 100 can comprise a locking mechanism. The locking mechanism can be configured to prevent electrical connector 145 from being disconnected from the vehicle while transferring electricity to/from the vehicle. For example, the locking mechanism could prevent a non-paying and/or a non-member user from disconnecting the electrical connector from a first vehicle of a paying and/or member user and connecting the electrical connector to another electric vehicle to steal a charge from the paying and/or member user. At least part of the locking mechanism can comprise a mechanical device configured to lock electrical connector 145 to the electric vehicle. In some embodiments, the locking mechanism can comprise a key lock or a combination lock. The locking mechanism can further comprise electrical components. The electrical components can permit the locking mechanism to engage and disengage electronically. The user(s) and/or user interface 115 can provide a code that the user(s) can later enter at user interface 115 in order to disengage the locking mechanism. The code can be specific to and/or reusable by the user (e.g., a pin number or the user's RFID tag) or the code can be a randomly generated code.

System 100 can comprise a termination mechanism. The termination mechanism can be configured to automatically terminate a transfer of electricity in the event that electrical connector 145 is disconnected from the electric vehicle or that system 100 is tampered with in some specified manner. The termination mechanism can be reset upon a properly received command from the user such that the transfer of electricity can continue. The termination mechanism can be configured to disengage when under certain conditions. The termination mechanism can disengage when the user correctly authenticates his/her identity to system 100. In many embodiments, the user can correctly authenticate himself/herself with a code similar to the code of the locking mechanism. The termination mechanism can disengage after a specified period of time. The termination mechanism can disengage when sensing a radio frequency identification signal that is provided by the user. The radio frequency identification signal can be provided by the vehicle of the user and/or the user's RFID tag.

In many embodiments, system 100 can comprise both the locking mechanism and the termination mechanism. System 100 can comprise a sensor to detect when electrical connector 145 has been disconnected from the vehicle. The sensor can be part of electrical connector 145.

In some embodiments, system 100 and/or user interface 115 can comprise a timing module. The timing module can be part of or can be separate from electric vehicle charging station 105 and/or user interface 115. The timing module can comprise a clock and/or a timer. The timing module can be configured to provide a clock time or a passage of an interval of time to user interface 115, as applicable, to perform one or more of its functions. In some embodiments, the timing module can be configured to operate similarly to timing module 970 (FIG. 9), as described below.

Returning now to the figures, FIG. 4 illustrates a block diagram of a system 400. System 400 is merely exemplary and is not limited to the embodiments presented herein. System 400 can be employed in many different embodiments or examples not specifically depicted or described herein. In some embodiments, system 400 and/or at least one component of system 400 can be configured to operate with or in conjunction with at least one computer system, as described above. In many embodiments, system 400 can be similar to system 100 (FIG. 1), as described above.

Referring to FIG. 4, system 400 can comprise transmission device 405. Transmission device 405 can be configured to transfer electricity between the transmission device and a rechargeable energy storage system of an electric vehicle. Transmission device 405 can be similar or identical to electric vehicle charging station 105 (FIG. 1). Likewise, the electric vehicle can be similar to the electric vehicle(s) described above with respect to system 100 (FIG. 1). The rechargeable energy storage system can be similar to the rechargeable energy storage system described above with respect to system 100 (FIG. 1).

Referring again to FIG. 4, system 400 can comprise a certified energy and demand meter 410. In the same or different embodiments, the certified energy and demand meter 410 can be similar or identical to electricity meter 110 (FIG. 1).

Referring again to FIG. 4, system 400 can comprise a terminal 415. Terminal 415 can be similar or identical to user interface 115 (FIG. 1). Terminal 415 can be configured to operate and/or provide an input to (e.g., communicate with) transmission device 405.

Referring again to FIG. 4, system 400 can comprise at least one communication device 425. Communication device 425 can be similar or identical to networking device 125 (FIG. 1). Communication device 425 can be configured to communicate with at least one external device 430 apart from the electric vehicle charging station. External device 430 can be similar or identical to the at least one external device 130 (FIG. 1), as described above.

Referring again to FIG. 4, system 400 can comprise a magnetic strip card reader 435 and/or a radio frequency identification reader 440. Magnetic strip card reader 435 can be similar to magnetic strip reader 135 (FIG. 1), and/or radio frequency identification reader 440 can be similar to radio frequency identification reader 140 (FIG. 1).

System 400 and/or terminal 415 can comprise a timing module. The timing module can be part of or can be separate from transmission device 405 and/or terminal 415. The timing module can comprise a clock and/or a timer. The timing module can be configured to provide a clock time or a passage of an interval of time to terminal 415, as applicable, to perform one or more of its functions. In some embodiments, the timing module can be configured to operate similarly to timing module 970 (FIG. 9), as described below.

Returning now to the figures, FIG. 5 illustrates a flow chart for an embodiment of a method 500. Method 500 is merely exemplary and is not limited to the embodiments presented herein. Method 500 can be employed in many different embodiments or examples not specifically depicted or described herein. In some embodiments, the activities, the procedures, and/or the processes of method 500 can be performed in the order presented. In other embodiments, the activities, the procedures, and/or the processes of the method 500 can be performed in any other suitable order. In still other embodiments, one or more of the activities, the procedures, and/or the processes in method 500 can be combined or skipped.

In many embodiments, method 500 can be configured to operate in real time. In the same or different embodiments, at least one procedure, process, or activity in method 500 can occur upon the occurrence of an operation by at least one of or a combination of the other procedures, processes, or activities of method 500. In the same or different embodiments, at least one procedure, process, or activity in method 500 can occur upon the occurrence of an operation by a combination of the other procedures, processes, or activities of method 500 when the other procedures, processes, or activities of method 500 occur in a specified sequence. In still other embodiments, at least one procedure, process, or activity in method 500 can be configured to occur upon the passage of a certain interval of time.

Referring to FIG. 5, method 500 comprises procedure 510 of facilitating communication between a user and at least one electric vehicle charging station. The user can be similar or identical to the user(s) of system 100 (FIG. 1), as described above. Meanwhile, each electric vehicle charging station of the at least one electric vehicle charging station can be similar or identical to electric vehicle charging station 105 (FIG. 1). The electric vehicle can be similar to the electric vehicle(s) described above with respect to system 100 (FIG. 1). Also, the rechargeable energy storage system can be similar or identical to the rechargeable energy storage system described above with respect to system 100 (FIG. 1).

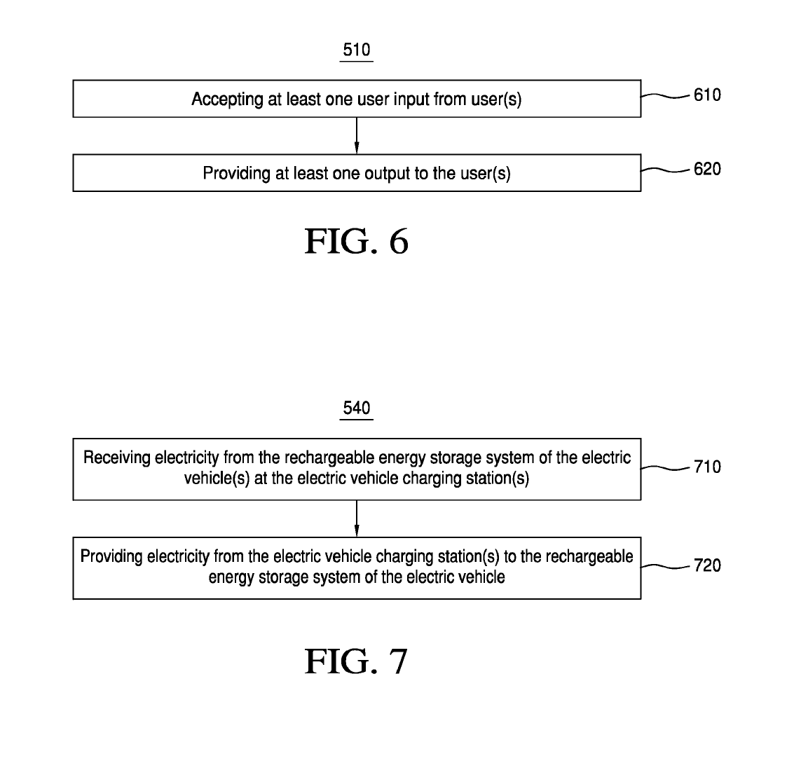

Referring now to FIG. 6, procedure 510 (FIG. 5) can comprise a process 610 of accepting at least one user input from the user(s). The user input(s) of process 610 can be similar to the user input(s) described above with respect to system 100 (FIG. 1). In some embodiments, process 610 can comprise accepting the user input(s) from the user(s) via a touch screen display, a keyboard, a keypad, a voice recognition device, a magnetic strip card reading device, a barcode reading device, a wireless networking device comprising at least a radio frequency communication device, a microwave communication device, or an infrared communication device, and/or a wired networking device. In further embodiments, process 610 can further comprise accepting at least one vehicle input from the electric vehicle(s). The vehicle input(s) can be similar or identical to the vehicle input(s) described above with respect to system 100 (FIG. 1).

The magnetic strip card reading device can be similar or identical to magnetic strip card reader 135 (FIG. 1). Meanwhile, the radio frequency communication device can be similar or identical to radio frequency identification reader 140 (FIG. 1). The wireless networking device can be similar or identical to the wireless networking device of networking device 125 (FIG. 1), and/or the wired networking device can be similar to the wired networking device of networking device 125 (FIG. 1). Process 610 can further comprise accepting user input(s) via at least one data cable for communication with the electric vehicle(s). The at least one data cable of process 610 can be similar or identical to the data cable(s) of user interface 115 (FIG. 1).

Referring again to FIG. 6, procedure 510 (FIG. 5) can comprise a process 620 of providing at least one output to the user(s). The output(s) can be similar or identical to the output(s) described above with respect to system 100 (FIG. 1). Process 620 can comprise providing the output(s) to the user(s) via at least one speaker. The speaker(s) can be similar or identical to the speaker(s) described above with respect to user interface 115 (FIG. 1).

Referring now back to FIG. 5, method 500 comprises procedure 520 of displaying at least text or at least one image on at least one display. The text and/or image can be similar or identical to at least one visual output of the visual outputs of system 100 (FIG. 1), as described above. The display(s) can be similar or identical to the display(s) of user interface 115 (FIG. 1). Where procedure 510 comprises process 620 (FIG. 6), procedure 520 can be omitted. In other embodiments, where method 500 comprises procedure 520, process 620 (FIG. 6) can be omitted.

Referring again to FIG. 5, method 500 comprises procedure 530 of transmitting data from the at least one electric vehicle charging station over at least one network. Procedure 530 can further comprise transmitting data from the electric vehicle charging station(s) over at least one network to at least one external device using at least one networking device. Procedure 530 can further comprise transmitting data to the electric vehicle charging station(s) over at least one network from at least one external device using at least one networking device. The external device(s) can be similar or identical to the external device(s) 130 (FIG. 1). The networking device(s) can be similar or identical to the networking device 125 (FIG. 1). The data can comprise at least a portion of the outputs of system 100 (FIG. 1), as described above. The network(s) can be similar or identical to the network(s) described above with respect to system 100 (FIG. 1).

Referring again to FIG. 5, method 500 comprises procedure 540 of transferring electricity between the at least one electric vehicle charging station and the rechargeable energy storage system of the electric vehicle(s). Procedure 540 comprise process 710 of receiving electricity from the rechargeable energy storage system of the electric vehicle(s) at the electric vehicle charging station(s), as illustrated in FIG. 7. Process 710 can further comprise receiving the electricity from the rechargeable energy storage system of the electric vehicle(s) at the electric vehicle charging station(s) in exchange for the value of the electricity.

Referring again to FIG. 7, procedure 540 (FIG. 5) can comprise process 720 of providing electricity from the electric vehicle charging station(s) to the rechargeable energy storage system of the electric vehicle. Process 720 can further comprise providing the electricity from the electric vehicle charging station(s) to the rechargeable energy storage system of the electric vehicle(s) in exchange for the value of the electricity. In some embodiments of procedure 540, only one of processes 710 and 720 is performed, and in other embodiments, both of processes 710 and 720 are performed (in any sequence) and repeated several times.

Returning now to the FIG. 5, method 500 can continue with procedure 550 of compiling data relating to the user(s) in a computer database. The database can be similar to computer database 120 (FIG. 1). The data relating to the user(s) can comprise the user data described above with respect to system 100 (FIG. 1).

Referring to FIG. 5, method 500 can comprise procedure 560 of transmitting data from at least one computer system to the electric vehicle charging station(s) over the at least one network. The data can comprise the first data. The first data can comprise the user input(s), the vehicle input(s), and/or the user data described above with respect to system 100 (FIG. 1).

Referring to FIG. 5, method 500 can comprise procedure 570 of transmitting data from the electric vehicle charging station(s) or the computer system(s) to another computer system. The other computer system can comprise a mobile device (e.g., a smart phone). Meanwhile, the data can comprise the second data. The second data can comprise the user input(s), the vehicle input(s), and/or the user data described above with respect to system 100 (FIG. 1).

Referring again to FIG. 5, method 500 can comprise procedure 580 of providing the user(s) with an electrical charge status of the rechargeable energy storage system of the electrical vehicle. Procedure 580 can comprise displaying the electrical charge status on the display(s). In other embodiments, procedure 580 can comprise sending the electrical charge status to the computer system of the user(s).

Referring to FIG. 5, in many embodiments, method 500 can comprise procedure 590 of receiving payment from the user for transferring the electricity between the electric vehicle charging station(s) and the rechargeable energy storage system of the electric vehicle(s). Procedure 590 of receiving payment from the user(s) can further comprise providing payment to the user(s).

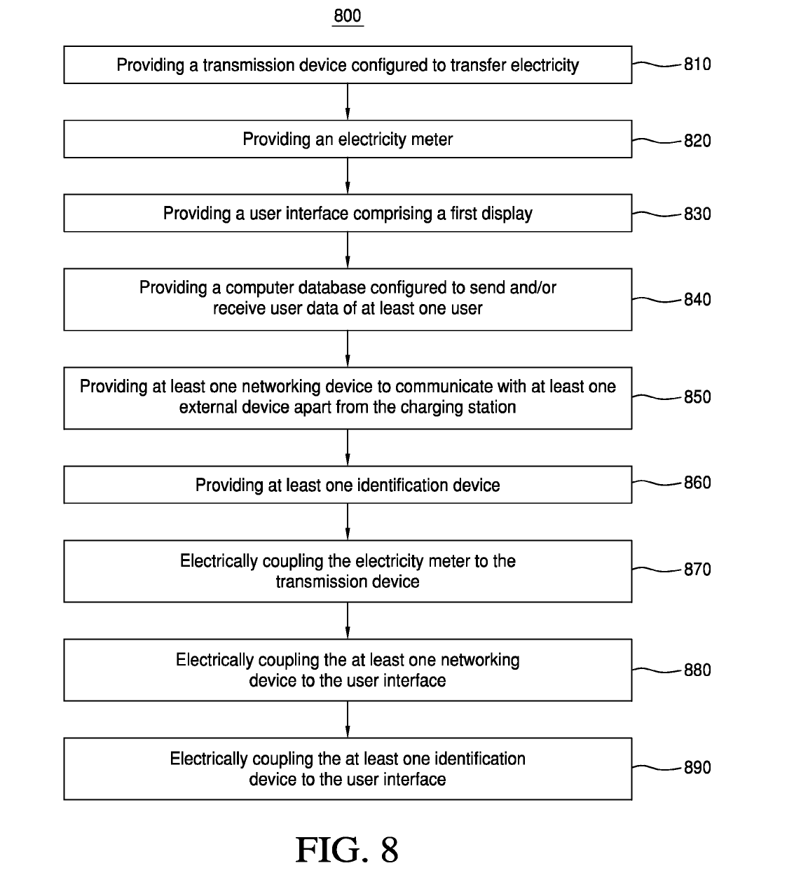

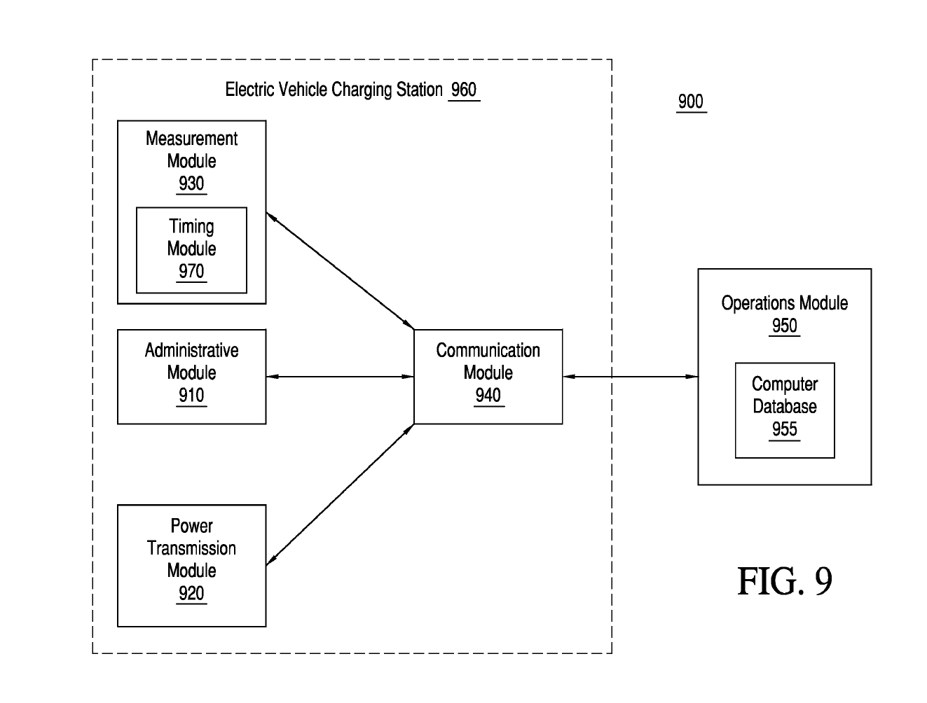

Turning to the next figure, FIG. 8 illustrates a flow chart for an embodiment of a method 800 of providing an electric vehicle charging station for charging a rechargeable energy storage system of an electric vehicle. Method 800 is merely exemplary and is not limited to the embodiments presented herein. Method 800 can be employed in many different embodiments or examples not specifically depicted or described herein. In some embodiments, the activities, the procedures, and/or the processes of method 800 can be performed in the order presented. In other embodiments, the activities, the procedures, and/or the processes of the method 800 can be performed in any other suitable order. In still other embodiments, one or more of the activities, the procedures, and/or the processes in method 800 can be combined or skipped.

In many embodiments, method 800 can be configured to operate in real time. In the same or different embodiments, at least one procedure, process, or activity in method 800 can occur upon the occurrence of an operation by at least one of or a combination of the other procedures, processes, or activities of method 800. In the same or different embodiments, at least one procedure, process, or activity in method 800 can occur upon the occurrence of an operation by a combination of the other procedures, processes, or activities of method 800 when the other procedures, processes, or activities of method 800 occur in a specified sequence. In still other embodiments, at least one procedure, process, or activity in method 800 can be configured to occur upon the passage of a certain interval of time.

Referring to FIG. 8, method 800 comprises procedure 810 of providing a transmission device configured to transfer electricity. The transmission device can comprise an electric vehicle charging station, and the electric vehicle charging station can be similar or identical to electric vehicle charging station 105 (FIG. 1). Procedure 810 can further comprise providing a transmission device configured to transfer electricity between the transmission device and the chargeable energy storage system. The rechargeable energy storage system can be similar or identical to the rechargeable energy storage system of system 100 (FIG. 1). The electric vehicle can be similar or identical to the electric vehicle(s) described above with respect to system 100 (FIG. 1).

Referring to FIG. 8, method 800 comprises procedure 820 of providing an electricity meter. In the same or different embodiments, the electricity meter can be similar or identical to electricity meter 110 (FIG. 1).

Referring to FIG. 8, method 800 comprises procedure 830 of providing a user interface comprising a first display. The first display can be configured to operate the electric vehicle charging station. The user interface can be similar or identical to user interface 115 (FIG. 1).

Referring to FIG. 8, method 800 comprises procedure 840 of providing a computer database configured to send and/or receive user data of at least one user. In the same or different embodiments, the computer database can be similar to computer database 120 (FIG. 1), and the user(s) can be similar or identical to the user(s) described above with respect to system 100 (FIG. 1).

Referring to FIG. 8, method 800 comprises procedure 850 of providing at least one networking device to communicate with at least one external device apart from the electric vehicle charging station. The networking device can be similar or identical to networking device 125 (FIG. 1). The external device can be similar or identical to external device 130 (FIG. 1).

Referring to FIG. 8, in many embodiments, method 800 can comprise a procedure 860 of providing at least one identification device. The identification device can comprise at least one of a magnetic strip card reader or a radio frequency identification reader. The magnetic strip card reader can be similar or identical to magnetic strip card reader 135 (FIG. 1), and/or the radio frequency identification reader can be similar or identical to radio frequency identification reader 140 (FIG. 1).

Referring again to FIG. 8, method 800 can comprise procedure 860 of electrically coupling the electricity meter to the transmission device, procedure 870 of electrically coupling the user interface to the transmission device, procedure 880 of electrically coupling the at least one networking device to the user interface, and/or procedure 890 of electrically coupling the at least one identification device to the user interface.

Turning to the next figure, FIG. 9 illustrates a block diagram of system 900 for charging a rechargeable energy storage system of an electric vehicle of a user. System 900 is merely exemplary and is not limited to the embodiments presented herein. System 900 can be employed in many different embodiments or examples not specifically depicted or described herein. In some embodiments, system 900 and/or at least one component of system 900 can be configured to operate with or in conjunction with at least one computer system, as described above. In many embodiments, at least part of system 900 can be similar to system 100 (FIG. 1), as described above. In some embodiments, the electric vehicle and/or the user can be similar to the one or more electric vehicle(s) and/or the user(s), respectively, described above with respect to system 100 (FIG. 1). The rechargeable energy storage system can also be similar or identical to the rechargeable energy storage system described above with respect to system 100 (FIG. 1).

Referring now to FIG. 9, system 900 comprises electric vehicle charging station 960 and operating module 950. System 900 and/or electric vehicle charging station 960 comprise administrative module 910. Administrative module 910 is configured to authenticate the user via radio frequency identification (RFID) and/or to administrate payment for charging the electric vehicle. Administrative module 910 can comprise an RFID transceiver/receiver, either or both of which can be similar to RFID reader 140 (FIG. 1), as described above. In many embodiments, administrative module 910 can be configured to receive RFID data from an RFID transmitter (e.g., a card, a key fob, etc.) via the RFID receiver in order to authenticate the user. The RFID data can be encoded with an identification number (e.g., account number) to uniquely identify the user. Accordingly, the user can simply bring the RFID transmitter within a certain proximity of the RFID receiver, and administrative module 910 can authenticate the user. However, in many embodiments, administrative module 910 can also require one or more additional inputs from the user to complete the authentication (e.g., a pin number/pass code associated with the RFID signal, or the like) to ensure/confirm that the user does not unintentionally authenticate and thereby accidentally permit use of administrative module 910 and/or system 900. In the same or different embodiments, the user can have a user profile associated with him/her similar to the user profile described above with respect to system 100 (FIG. 1) and can be a member of a charging network of electric vehicle charging stations (e.g., electric vehicle charging station 960, as described below). The charging network can be similar to the charging network described above for system 100 (FIG. 1). In various embodiments, computer database 955, as described below, can be configured to store the user profile of the user.

Administrative module 910 can directly and/or indirectly administrate payment for the charge. Where administrative module 910 is directly administrating payment for the charge, administrative module 910 and/or system 900 can comprise a payment device for collecting and distributing currency and/or for billing an account of the user (e.g., credit card/debit card reader, or the like). Administrative module 910 can operate as part of a user interface similar to user interface 115 (FIG. 1), as described above, and/or can be configured to directly bill the user for the charge and/or receive payment for the charge via the payment device. In other embodiments, where administrative module 910 is indirectly administrating payment for the charge, administrative module 910 can administrate payment by providing the RFID data to operations module 950 via communications module 940, as described below, and operations module 950 can complete the administration of payment by the user for the charge. Operations module 950 can utilize the identity and/or user profile of the user as determined by the RFID data communicated to operations module 950 by administrative module 910 to automatically bill an account of the user that is associated with the identity and/or user profile of the user and/or to bill the user for the charge and receive payment for the charge at a subsequent time.

System 900 and/or electric vehicle charging station 960 also comprise power transmission module 920. Power transmission module 920 is configured to make electricity available to charge the rechargeable energy storage system. Power transmission module 920 can be configured to control electric vehicle charging station 960, as described below, in order to control making the electricity available to charge the rechargeable energy storage system. Power transmission module 920 can be configured to control the electricity made available to the rechargeable energy storage system in a manner similar to system 100 and/or user interface 115 (FIG. 1), as described in detail above. Power transmission module 920 can be configured to communicate with the electric vehicle(s) via a data line similar to the data line described above with respect to system 100 (FIG. 1). Transmission module 920 can be configured to receive firmware updates from operations module 950 via communications module 940.

System 900 and/or electric vehicle charging station 960 further comprise measurement module 930. Measurement module 930 is configured to measure the electricity used to charge the rechargeable energy storage system. Measurement module 930 can comprise an electricity meter similar or identical to electricity meter 110 (FIG. 1). Measurement module 930 can be configured to measure one or more parameters of the electricity (e.g., amperage, wattage, etc.) and to relay that information to operations module 950 via communications module 940. Operations module 950 can use the information measured by measurement module 930 to calculate the payment for the electricity by the user(s) and/or to accumulate data on the user(s)' history of use of the charging network. Measurement module 930 can be reprogrammable to permit new configurations for measurement module 930. Measurement module 930 can receive firmware updates from operations module 950 via communications module 940.

System 900 and/or electric vehicle charging station 960 further comprise timing module 970. Timing module 970 is configured to measure at least one of (a) a first quantity of time during which the electricity is used to charge the rechargeable energy storage system or (b) a second quantity of time during which the electric vehicle occupies a space located adjacent to the power transmission module. Timing module 970 can also be configured to update the system clock time of timing module 970 and/or system 900 as provided by operations module 950 or any timekeeping source external to system 900. Accordingly, timing module 970 can be configured to keep track both of durations of time and the general clock time. In many embodiments, timing module 970 can be part of measurement module 930. In other embodiments, timing module 970 can be part of operations module 950.

System 900 and/or electric vehicle charging station 960 further comprise communication module 940. Communication module 940 is configured to permit communications among administrative module 910, power transmission module 920, measurement module 930, timing module 970, and between: (a) operations module 950; and (b) administrative module 910, power transmission module 920, measurement module 930, and timing module 970. Communication module 940 and administrative module 910 can be configured to communicate with each other via an inter-integrated circuit (I²C) computer bus. Communication module 940 and power transmission module 920 can be configured to communicate with each other via parallel and/or series (e.g., Recommended Standard 232) communication standards. Communication module 940 and measurement module 930 (and timing module 970 when applicable) can be configured to communicate with each other via Electronic Industries Alliance (ETA) 485 (i.e., Recommended Standard 485). Communications module 940 can be configured to communicate with operations module 950 (and timing module 970 when applicable) via at least one of a cellular telephone network connection, one or more computer network connections (e.g., IEEE 802.3 (Ethernet), IEEE 802.11 (Wireless Local Area Network)), or a power line communication connection. Communication module 940 can be configured to encrypt outgoing communications and/or decrypt incoming communications between communications module 940 and operations module 950. The encryption/decryption can help protect the security of the communications between communications module 940 and operations module 950.

System 900 can comprise operations module 950. In many embodiments, operations module 950 can facilitate making electricity available to charge the rechargeable energy storage system. Operations module 950 can be configured to instruct power transmission module 920 as to how to make the electricity available to the rechargeable energy storage system. Operations module 950 can be configured to coordinate scheduling charge times and reservations for charge times for the charging network, to optimize how power transmission module 920 makes electricity available to the electric vehicle, to coordinate information provided to the user (e.g., advertisements, etc.), and to manage the user profile of the user similar to the various embodiments of system 100 (FIG. 1), as described above. Operations module 950 can also be configured to assist administrative module 910 in administering payment for the charge of the rechargeable energy storage system, as described above.

Referring again to FIG. 9, operations module 950 can comprise computer database 955. Operations module 950 can be configured to communicate with communications module 940 or other parts of system 900, but is not a part of system 900. Computer database 955 can be similar or identical to computer database 120, as described above. Operations module 950 can be configured to operate on and/or in conjunction with a computer system similar to computer system 200 (FIG. 2), as described above.

In many embodiments of system 900, in operation, administrative module 910 can receive the RFID data from the user and provide it to operations module 950 via communications module 940 to verify that the RFID data is associated with a valid user account. Upon authenticating the user, operations module 950 can respond to one or more inputs from the user, which can be similar to the user input(s) described above with respect to system 100 (FIG. 1), to coordinate making the electricity available to charge the rechargeable energy storage system. In some examples, operations module 950 can also check to see if the user has reserved a period of time to use electric vehicle charging station 960, as described below, and/or to confirm that the user has a reservation for electric vehicle charging station 960 for the time he/she is requesting a charge for his/her electric vehicle. Power transmission module 920 can then respond to commands from operations module 950 to make the electricity available to charge the rechargeable energy storage system. Meanwhile, measurement module 930 can measure the electricity being used to charge the rechargeable energy storage system and/or timing module 970 can measure the at least one of (a) the first quantity of time during which the electricity is used to charge the rechargeable energy storage system or (b) the second quantity of time during which the electric vehicle occupies a space located adjacent to power transmission module 920.

Measurement module 930 and/or timing module 970 can then provide the measurements to operations module 950 such that operations module 950 can assess an amount of payment to the user(s). The amount of payment can be based on at least one of (a) the electricity measured by measurement module 930, (b) the first quantity of time measured by timing module 970, (c) the second quantity of time measured by timing module 970, (d) permitting the user to charge the rechargeable energy storage system (e.g., by permitting general accessibility and/or by permitting the user(s) to make a reservation), (e) permitting the electric vehicle to occupy a space located adjacent to the electric vehicle charging station, or (f) a fractional quantity of the rechargeable energy storage system charged. In the same or different embodiments, the amount of the payment can be based on an approximate distance (e.g., kilometers (miles)) the user needs to travel and a related amount of charge necessary to travel the desired distance. Operations module 950 can then either automatically bill the account (e.g., a checking or savings account) of the user for the amount of the payment, generate a bill of the amount of the payment to be paid later by the user, or charge the credit card or debit card on file with the user's account.

For example, with regard to the amount of payment, operations module 950 could assess a payment based on the first quantity of time measured by timing module 970 (e.g., the time duration of the charge) and the second quantity of time (e.g., the time duration occupying space at electric vehicle charging station 960). The cost assessed per unit of time can be the same for both quantities of time or it can be different. Likewise, the cost assess per unit of time can be constant (e.g., a flat rate) for each type of quantity of time or it can change (e.g., increase or decrease). In another example, operations module 950 could assess a payment based on the cost of the electricity used to charge the rechargeable energy storage system, as measured by measurement module 930, instead of or in addition to the amount of payment assessed for the first quantity of time measured.

Accordingly, in a more detailed example, the operations module could assess a first cost per minute (e.g., 1.50 United States dollars per hour) for the duration of time spent charging the rechargeable energy storage system. Meanwhile, the operations module could assess a second cost per minute (e.g., 0.05 United States dollars per minute) for any time spent occupying a space adjacent to electric vehicle charging station 960 while the rechargeable energy storage system is receiving the charge. The second cost could then be continually increased at a particular interval (e.g., each minute) by a particular amount (e.g., 0.01 United States dollars).

In the same or different examples, operations module 950 can assess individual transactional payments. Adding to the above example, operations module 950 could assess a transactional payment (e.g., 3.00 United States dollars) for a reservation of electric vehicle charging station 960 and/or a transactional payment (e.g., 8.00 United States dollars) for a temporary license to occupy the space adjacent to electric vehicle charging station 960. In a different example, operations module 950 can assess a transactional payment (e.g., 10.00 United States dollars) for a fractional quantity (e.g., 25% of capacity) of the rechargeable energy storage system charged.

The operations module 950 can utilize any combination of these various pricing schemes when assessing a payment. In various embodiments, the user(s) and/or members of the charging network may be able to choose a preferred pricing scheme while in other embodiments, the operator of the charging network may decide the pricing scheme. Likewise, the pricing scheme can include a payment to the owner of the land on which electric vehicle charging station 960 is located. The payment to the owner of the land can be based on any of the same pricing options provided for charging the rechargeable energy storage system. The pricing scheme assessed by operations module 950 can also be determined, at least in part, based on the type of charging (e.g., level 2 or level 3) used to charge the rechargeable energy storage system.

In many embodiments, system 900 can comprise electric vehicle charging station 960. In various embodiments, electric vehicle charging station 960 can be similar or identical to electric vehicle charging station 105 (FIG. 1). Administrative module 910, power transmission module 920, measurement module 930, timing module 970, and/or communication module 940 can be part of and/or can be located at electric vehicle charging station 960. Operations module 950 and/or timing module 970 can be separate from and/or located apart from electric vehicle charging station 960.

Returning now to the figures, FIG. 10 illustrates a flow chart for an embodiment of method 1000 of operating an electric vehicle charging station to charge a rechargeable energy storage system of an electric vehicle of a user. Method 1000 is merely exemplary and is not limited to the embodiments presented herein. Method 1000 can be employed in many different embodiments or examples not specifically depicted or described herein. In some embodiments, the activities, the procedures, and/or the processes of method 1000 can be performed in the order presented. In other embodiments, the activities, the procedures, and/or the processes of the method 1000 can be performed in any other suitable order. In still other embodiments, one or more of the activities, the procedures, and/or the processes in method 1000 can be combined or skipped. In many embodiments, at least one of the electric vehicle charging station, the electric vehicle, the user, or the rechargeable energy storage system can be similar to electric vehicle charging station 960 (FIG. 9), the electric vehicle described above with respect to system 900 (FIG. 9), the user(s) described above with respect to system 900 (FIG. 9), and/or the rechargeable energy storage system described above with respect to system 900 (FIG. 9).

In many embodiments, method 1000 can be configured to operate in real time. In the same or different embodiments, at least one procedure, process, or activity in method 1000 can occur upon the occurrence of an operation by at least one of or a combination of the other procedures, processes, or activities of method 1000. In the same or different embodiments, at least one procedure, process, or activity in method 1000 can occur upon the occurrence of an operation by a combination of the other procedures, processes, or activities of method 1000 when the other procedures, processes, or activities of method 1000 occur in a specified sequence. In still other embodiments, at least one procedure, process, or activity in method 1000 can be configured to occur upon the passage of a certain interval of time.

Referring now to FIG. 10, method 1000 comprises procedure 1001 of receiving RFID data from the user. The RFID data can be similar or identical to the RFID data described above with respect to system 900 (FIG. 9).

Referring again to FIG. 10, method 1000 comprises procedure 1002 of providing the RFID data to an operations module to authenticate an identity of the user. In various embodiments, the operations module can be located either remote from the electric vehicle charging station or at the electric vehicle charging station. In many embodiments, the operations module can be similar or identical to operations module 950, as described above. In various embodiments, the operations module can authenticate the identity of the user in a manner similar to that described above for system 900 (FIG. 9). In some embodiments, the operations module can comprise a computer database similar to computer database 955 (FIG. 9).

Referring again to FIG. 10, method 1000 comprises procedure 1003 of receiving a request to charge the rechargeable energy storage system of the electric vehicle. Procedure 1003 can comprise receiving one or more user inputs, vehicle inputs, and/or database inputs, as described above with respect to system 100 (FIG. 1).

Referring again to FIG. 10, method 1000 comprises procedure 1004 of making the electricity available from the electric vehicle charging station to the rechargeable energy storage system of the electric vehicle after receiving the request. In various embodiments, procedure 1004 can comprise making the electricity available from the electric vehicle charging station to the rechargeable energy storage system of the electric vehicle via an electric vehicle charging station similar to electric vehicle charging station 960 (FIG. 9) and/or controlling making the electricity available to charge the rechargeable energy storage system of the electric vehicle with a power transmission module similar to power transmission module 920 (FIG. 9).

In many embodiments, procedures 1001-1004 can be performed and/or can occur sequentially. In some embodiments, procedure 1001 can be performed and/or can occur before procedure 1002, although procedure 1001 and procedure 1002 may be performed and/or may occur approximately simultaneously. In further embodiments, procedure 1001 and/or procedure 1002 can be performed and/or can occur before procedure 1003.

Referring again to FIG. 10, method 1000 comprises procedure 1005 of providing at least one of (a) a first measurement of a quantity of electricity used to charge the rechargeable energy storage system of the electric vehicle, (b) a second measurement of a first quantity of time during which the rechargeable energy storage system is being charged, or (c) a third measurement of a second quantity of time during which the electric vehicle occupies a space located adjacent to the electric vehicle charging station, to the operations module. Providing the first measurement to the operations module can comprise measuring the first measurement (e.g., with a measurement module similar or identical to measurement module 930 (FIG. 9)) and then providing the measurement to the operation module. Providing the second measurement to the operations module can comprise measuring the second measurement (e.g., with a timing module similar or identical to timing module 970 (FIG. 9)) and then providing the second measurement to the operations module. Providing the third measurement to the operations module can comprise measuring the third measurement (e.g., with the timing module) and then providing the third measurement to the operations module.

Referring again to FIG. 10, method 1000 comprises procedure 1006 of providing information received from the user to the operations module. In various embodiments, procedure 1006 can comprise providing information received from the user to the operations module to form and/or update a user profile of the user. The user profile can be similar or identical to the user profile described above with respect to system 900 (FIG. 9).

Referring again to FIG. 10, method 1000 comprises procedure 1007 of administrating payment by the user based on the at least one of: (a) the first measurement, (b) the second measurement, (c) the third measurement, (d) permitting the user to charge the rechargeable energy storage system, (e) permitting the electric vehicle to occupy a space located adjacent to the electric vehicle charging station, or (f) a fractional quantity of the rechargeable energy storage system charged. Procedure 1007 can be performed by the operations module and/or can be performed similarly to as described above with respect to operations module 950 (FIG. 9) and system 900 (FIG. 9).

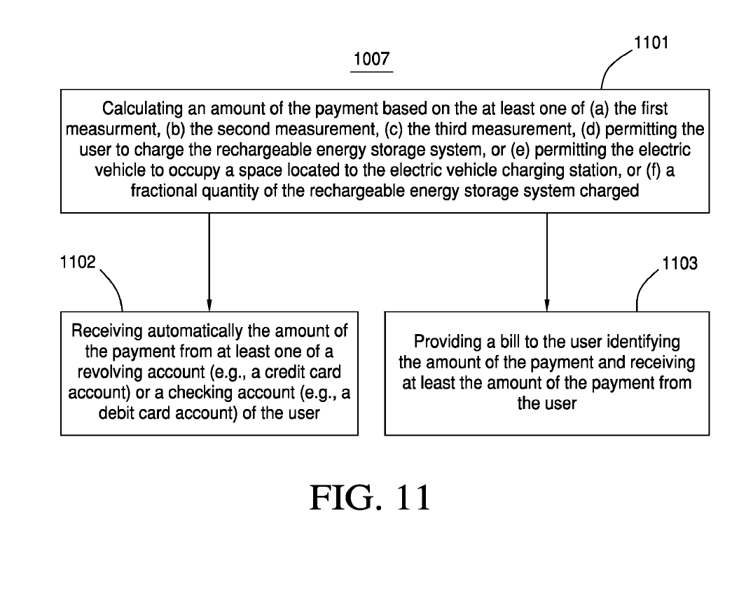

Returning now to the figures, FIG. 11 illustrates a flow chart for an exemplary embodiment of procedure 1007 of administrating payment by the user, according to one embodiment. In some embodiments, procedure 1007 can comprise process 1101 of calculating an amount of the payment based on the at least one of (a) the first measurement, (b) the second measurement, (c) the third measurement, (d) permitting the user to charge the rechargeable energy storage system, or (e) permitting the electric vehicle to occupy a space located adjacent to the electric vehicle charging station, or (f) a fractional quantity of the rechargeable energy storage system charged. In various embodiments, procedure 1008 can comprise one of: (a) process 1102 of receiving automatically the amount of the payment from at least one of a revolving account (e.g., a credit card account) or a checking account (e.g., a debit card account) of the user or (b) process 1103 of providing a bill to the user identifying the amount of the payment and receiving at least the amount of the payment from the user.

Referring back now to FIG. 10, method 1000 comprises procedure 1008 of providing information regarding the user from the computer database to the electric vehicle charging station. In the same or different embodiments, the information regarding the user can comprise information regarding one or more reservations of time by the user to use one or more electric vehicle charging stations of a charging network similar to the charging network described above with respect to system 900 (FIG. 9). In the same or different embodiments, the charging network can comprise the electric vehicle charging station that is performing procedure 1004. In many embodiments, the information regarding the user can comprise information regarding a history of use of the charging network by the user.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 510, 520, 530, 540, 550, 560, 570, 580, and 590, procedures 810, 820, 830, 840, 850, 860, 870, 880, and 890, procedures 1001-1008, processes 610 and 620, processes 710 and 720, and processes 1101-1103 may be comprised of many different activities, processes, and procedures and be performed by many different modules, in many different orders, that any element of FIGS. 1-11 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A system for charging a rechargeable energy storage system of an electric vehicle, the system comprising:
an administrative module configured to authenticate a user via radio frequency identification and to administrate payment by the user for using the system to charge the rechargeable energy storage system;
an electricity transmission module configured to make electricity available to charge the rechargeable energy storage system;
a measurement module configured to measure a first measurement of the electricity used to charge the rechargeable energy storage system;
a timing module configured to measure at least one of (a) a second measurement of a first quantity of time during which the electricity is used to charge the rechargeable energy storage system or (b) a third measurement of a second quantity of time during which the electric vehicle occupies a space located adjacent to the electricity transmission module;
a communication module configured to intermediate communication between an operations module, the administrative module, the electricity transmission module, the measurement module, and the timing module; and
an electric vehicle charging station, the electric vehicle charging station comprising the administrative module, the electricity transmission module, the measurement module, the timing module, and the communication module;
wherein:
the operations module is located remotely from the electric vehicle charging station.

2) The system of claim 1 wherein:
the electric vehicle charging station comprises a first display and a second display.

3) The system of claim 2 wherein at least one of:
the first display comprises a first touch screen display; or
the second display comprises a second touch screen display.

4) The system of claim 2 wherein at least one of:
the first display has a diagonal measurement of less than or equal to approximately 44 centimeters; or
the second display has a diagonal measurement of greater than or equal to approximately 91 centimeters.

5) The system of claim 2 wherein:
the system comprises the operations module.

6) The system of claim 1 wherein:
at least one of the operations module or the administrative module is configured to calculate an amount of the payment by the user based on at least one of: (a) the first measurement, (b) the second measurement, (c) the third measurement, (d) permitting the user to charge the rechargeable energy storage system, (e) permitting the electric vehicle to occupy the space located adjacent to the electric vehicle charging station, or (f) a fractional quantity of the rechargeable energy storage system charged.

7) The system of claim 6 wherein:
at least one of the administrative module or the operations module is configured: (a) to receive automatically the amount of the payment by the user from at least one of a revolving account or a checking account of the user, or (b) to provide a bill to the user specifying the amount of the payment by user and to receive the amount of the payment by the user from the user.

8) The system of claim 6 wherein:
the system comprises the operations module.

9) The system of claim 1 wherein:
the electric vehicle charging station comprises a first display and a second display.
the first display comprises a touch screen display;
the first display has a diagonal measurement of less than or equal to approximately 44 centimeters;
the second display has a diagonal measurement of greater than or equal to approximately 91 centimeters;
the system comprises the operations module;
at least one of the operations module or the administrative module is configured to calculate an amount of the payment by the user based on at least one of: (a) the first measurement, (b) the second measurement, (c) the third measurement, (d) permitting the user to charge the rechargeable energy storage system, (e) permitting the electric vehicle to occupy the space located adjacent to the electric vehicle charging station, or (f) a fractional quantity of the rechargeable energy storage system charged; and
at least one of the administrative module or the operations module is configured: (a) to receive automatically the amount of the payment by the user from at least one of a revolving account or a checking account of the user, or (b) to provide a bill to the user specifying the amount of the payment by user and to receive the amount of the payment by the user from the user.

10) A method of providing a system for charging a rechargeable energy storage system of an electric vehicle, the method comprising:
providing an electric vehicle charging station, wherein providing the electric vehicle charging station comprises:
providing an administrative module configured to authenticate a user via radio frequency identification and to administrate payment by the user for using the system to charge the rechargeable energy storage system;
providing an electricity transmission module configured to make electricity available to charge the rechargeable energy storage system;
providing a measurement module configured to measure a first measurement of the electricity used to charge the rechargeable energy storage system; and
providing a timing module configured to measure at least one of (a) a second measurement of a first quantity of time during which the electricity is used to charge the rechargeable energy storage system or (b) a third measurement of a second quantity of time during which the electric vehicle occupies a space located adjacent to the electricity transmission module;
and
configuring an operations module, the administrative module, the electricity transmission module, the measurement module, and the timing module to communicate with each other, wherein the operations module is located remotely from the electric vehicle charging station.

11) The method of claim 10 wherein:
providing the electric vehicle charging station further comprises providing a first display and a second display.

12) The method of claim 11 wherein:
providing the first display and the second display comprises providing at least one of a first touch screen display as the first display or a second touch screen display as the second display.

13) The method of claim 10 further comprising:
configuring at least one of the operations module or the administrative module to calculate an amount of the payment by the user based on at least one of: (a) the first measurement, (b) the second measurement, (c) the third measurement, (d) permitting the user to charge the rechargeable energy storage system, (e) permitting the electric vehicle to occupy the space located adjacent to the electric vehicle charging station, or (f) a fractional quantity of the rechargeable energy storage system charged.

14) The method of claim 13 wherein:
at least one of the administrative module or the operations module is configured: (a) to receive automatically the amount of the payment by the user from at least one of a revolving account or a checking account of the user, or (b) to provide a bill to the user specifying the amount of the payment by user and to receive the amount of the payment by the user from the user.

15) The system of claim 13 wherein:
the system comprises the operations module.

16) A method of operating an electric vehicle charging station to charge a rechargeable energy storage system of an electric vehicle, at least part of the method being implemented via execution of computer instructions configured to run at one or more computer processing modules and configured to be stored in one or more non-transitory computer memory storage modules, the method comprising:
receiving radio frequency identification data from a user of the electric vehicle charging station;
providing the radio frequency identification data to an operations module to authenticate an identity of the user, the operations module being located remotely from the electric vehicle charging station and comprising a computer database;
receiving a request from the user to charge the rechargeable energy storage system of the electric vehicle;
making electricity available from the electric vehicle charging station to the rechargeable energy storage system of the electric vehicle after receiving the request;
providing at least one of (a) a first measurement of a quantity of electricity used to charge the rechargeable energy storage system of the electric vehicle, (b) a second measurement of a first quantity of time during which the rechargeable energy storage system is being charged, or (c) a third measurement of a second quantity of time during which the electric vehicle occupies a space located adjacent to the electric vehicle charging station, to the operations module;
providing information received from the user to the operations module; and
administrating payment by the user based on the at least one of: (a) the first measurement, (b) the second measurement, (c) the third measurement, (d) permitting the user to charge the rechargeable energy storage system, (e) permitting the electric vehicle to occupy the space located adjacent to the electric vehicle charging station, or (f) a fractional quantity of the rechargeable energy storage system charged.

17) The method of claim 16 further comprising:
receiving the information received from the user at a first display of multiple displays of the electric vehicle charging station.

18) The method of claim 17 further comprising:
providing other information regarding the user from the computer database to the electric vehicle charging station; and
displaying the other information regarding the user at a second display of the multiple displays.

19) The method of claim 16 wherein:
providing the first measurement to the operations module comprises measuring the first measurement;
providing the second measurement to the operations module comprises measuring the second measurement; and
providing the third measurement to the operations module comprises measuring the third measurement.

20) The method of claim 19 wherein:
administrating the payment by the user comprises calculating an amount of the payment based on the at least one of: (a) the first measurement, (b) the second measurement, (c) the third measurement, (d) permitting the user to charge the rechargeable energy storage system, (e) permitting the electric vehicle to occupy the space located adjacent to the electric vehicle charging station, or (f) the fractional quantity of the rechargeable energy storage system charged; and
the method further comprises one of: (a) receiving automatically the amount of the payment from at least one of a revolving account or a checking account of the user, or (b) providing a bill to the user specifying the amount of the payment and receiving the amount of the payment from the user.
